(19) United States
(12) Patent Application Publication
(10) Pub. No.: US 2022/0388705 A1
(43) Pub. Date: Dec. 8, 2022

(54) BOTTLE WITH SEPARABLE PORTIONS

(71) Applicant: DENNEROLL HOLDINGS PTY LTD, CROMER (AU)

(72) Inventor: Adrian Dennewald, Waverton (AU)

(21) Appl. No.: 17/705,234

(22) Filed: Mar. 25, 2022

Related U.S. Application Data
(60) Provisional application No. 63/166,229, filed on Mar. 25, 2021.

(51) Int. Cl. B65D 1/02; B65D 1/40

(52) U.S. Cl. CPC B65D 1/0223; B65D 1/40; A47K 5/1202

(57) ABSTRACT

A bottle can include an upper portion having a first coupling section and a lower portion having a second coupling section. The first coupling section can be configured to be removably coupled with the second coupling section for removably coupling the upper and lower portions of the bottle with one another. One of the coupling sections can include a first groove and the other one of the coupling sections can include a tongue. When the upper and lower portions of the bottle are coupled with one another, the groove engages the tongue and a seal sealingly engages one or more sealing surfaces of the upper and lower portions of the bottle.

### CROSS REFERENCE TO RELATED APPLICATIONS

This application claims the benefit of U.S. Provisional Patent Application No. 63/166,229 filed Mar. 25, 2021, the entire contents of which are hereby incorporated by reference herein.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

### Field of the Invention

The present disclosure relates generally to containers and more specifically relates to bottles.

### Description of the Related Art

Bottles are often used by consumers and others for holding a wide variety of goods, including but not limited to fluids or semi-fluids such as shampoos, conditioners, lotions, oils, other body care products and virtually countless other items, such as condiments and cleaning products among many others. Conventional bottles can make it difficult or impractical to utilize the entirety of a bottle's contents, such as due to the contents sticking to the interior of the bottle or, as another example, due to the feed tube of a hand pump mechanism not extending to the bottom of the bottle. Consequently, at least some of the contents are often wasted or otherwise go unused. What's more, some products such as high-end body care products can be relatively expensive and wasted contents amounts to wasted money. A need exists in the art for improved bottles.

### BRIEF SUMMARY OF THE INVENTION

Applicant has created new and useful devices, systems and methods for facilitating utilization of the entirety of the contents of a bottle.

In at least one embodiment, a bottle, such as an at least partially plastic bottle, can include two or more at least partially separable portions for allowing a user to readily access the interior and/or contents of the bottle. For example, first and second bottle portions can be configured to be openable or optionally uncoupled from one another for facilitating removal of the remaining contents of the bottle, such as once the primary removal means (e.g., squeezing or pumping) becomes ineffective or impractical, for instance due to a relatively small amount of contents remaining in the bottle (or otherwise). The portions, which can be or include halves or other portions or parts, such as top and bottom parts, upper and lower parts, first and second parts, or other parts, can be configured to couple and uncouple with one another for accessing at least a portion of the interior of the bottle. In at least one embodiment, a bottom or lower portion can be or include a bowl, cup or similar portion.

In at least one embodiment, a bottle can include an upper portion having a top end with a mouth and a longitudinally opposite bottom end, and a lower portion having a top end and a longitudinally opposite closed base, wherein the bottom end of the upper portion and the top end of the lower portion are open, and wherein the bottom end of the upper portion and the top end of the lower portion are configured to be removably and sealingly coupled with one another. The bottom end of the upper portion can include a neck, such as a recessed neck, which can have an exterior surface, such as a radially, perimetrically, perimetrally or other exterior surface. The top end of the lower portion can include an interior surface, such as a radially, perimetrically, perimetrally or other interior surface. The exterior surface of the neck and the interior surface of the lower portion can be configured to sealingly engage one another. One or more seals can be disposed on the exterior surface of the neck, interior surface of the lower portion, or otherwise disposed for supporting sealing engagement between two or more bottle portions.

In at least one embodiment, a bottle can include a plurality of male couplers coupled to one of the upper and lower portions and a plurality of female couplers coupled to the other of the upper and lower portions. The plurality of male couplers can be configured to releasably couple with the plurality of female couplers. In at least one embodiment, one or more bottle portions can have a single coupler. In at least one embodiment, one or more bottle portions can have one or more male couplers and one or more female couplers. One or more couplers can be or include any type of coupler for supporting removable coupling of two or more bottle portions according to an implementation of the disclosure. Examples of suitable couplers include flexible snap-fit or interference fit couplers as shown in the figures for illustrative purposes, among many others, such as threads, tongue and groove couplers, hook and groove couplers, and other couplers capable of being integrally formed with or otherwise coupled to one or more bottle portions. In at least one embodiment, the couplers can be absent and two or more bottle portions can be configured to couple with one another via interference fit or otherwise.

In at least one embodiment, a bottle can include one or more seals, such as a rubber or other elastomeric seal, and one or more seals can be sized and arranged for being fluidically isolated from an interior volume of the bottle. For example, a seal can be coupled to at least one bottle portion and can be fluidically isolated from the interior of the bottle when two bottle portions are coupled together, which can be advantageous, for instance, in implementations of the disclosure wherein the seal or seal material could negatively affect the contents of the bottle or vice versa. In at least one embodiment, a bottle can include an upper portion and a lower portion made from different materials. In at least one embodiment, one of the upper and lower portions of a bottle can be made from a more rigid material than the other of the upper and lower portions, which can facilitate coupling and/or uncoupling of the bottle portions.

In at least one embodiment, a bottle can include a hand pump coupled to the mouth and a feed tube having a first end coupled to the hand pump and a second end disposed within the bottle. The bottle can be configured so that the upper and lower portions can be uncoupled from one another, such as for gaining access to contents of the bottle that either have not been removed or cannot be removed via the hand pump and feed tube. In at least one embodiment, the mouth of the upper portion of a bottle can be or include a first mouth and the top end of the lower portion of the bottle can be or include a second mouth disposed vertically beneath the first mouth.

In at least one embodiment, a bottle can include an upper portion having a primary mouth and a first coupling section, and a lower portion having a closed base, a secondary mouth and a second coupling section. In at least one embodiment, the first coupling section can be configured to be disposed at least partially through the secondary mouth and removably coupled with the second coupling section for removably coupling the upper and lower portions of the bottle with one another. In at least one embodiment, the first coupling section can include an exterior surface, a first groove that extends radially inwardly relative to the exterior surface, a first tongue that extends radially outwardly from the exterior surface, the first tongue being disposed below the first groove, a seal that extends radially outwardly relative to the exterior surface, the seal being disposed below the first tongue, and a downwardly facing rim. In at least one embodiment, the second coupling section can include an interior surface and an exterior surface, a second tongue that extends radially inwardly from the exterior surface, a second groove that extends radially outwardly from the interior surface, the second groove being disposed below the second tongue, a sealing surface disposed below the second groove, and an upwardly facing rim. In at least one embodiment, when the upper and lower portions of the bottle are coupled with one another, the first groove engages the second tongue, the first tongue engages the second groove, the seal sealingly engages the sealing surface, and the downwardly facing rim abuts the upwardly facing rim.

In at least one embodiment, the primary mouth can be smaller than the secondary mouth. In at least one embodiment, the first tongue can be or include a ramped or curved surface that increases in diameter from bottom to top. In at least one embodiment, the first tongue can intersect a wall of the first groove.

In at least one embodiment, the seal can be formed integrally with the first coupling section. In at least one embodiment, the seal can be an elastically deformable sealing element disposed in a seal groove that extends radially inwardly relative to the exterior surface of the first coupling section.

In at least one embodiment, a bottle can include an upper portion having a primary mouth and a first coupling section, and a lower portion having a closed base and a second coupling section. In at least one embodiment, the first coupling section can be configured to be removably coupled with the second coupling section for removably coupling the upper and lower portions of the bottle with one another. In at least one embodiment, the first coupling section can include an exterior surface, a first groove that extends radially inwardly relative to the exterior surface, a first sealing surface that extends around the exterior surface, the first sealing surface being disposed below the first groove, and a seal disposed adjacent the first sealing surface. In at least one embodiment, the second coupling section can include an interior surface, a tongue that extends radially inwardly from the interior surface, and a second sealing surface disposed below the tongue. In at least one embodiment, when the upper and lower portions of the bottle are coupled with one another, the first groove engages the tongue and the seal sealingly engages both sealing surfaces.

In at least one embodiment, a lower wall of the first groove can include a ramped or curved surface that increases in diameter from bottom to top. In at least one embodiment, the first sealing surface can include a second groove that extends radially inwardly relative to the exterior surface of the first coupling section. In at least one embodiment, the second sealing surface can include a third groove that extends radially outwardly relative to the interior surface of the second coupling section.

In at least one embodiment, the seal can be formed integrally with the first coupling section. In at least one embodiment, the seal can be an elastically deformable sealing element disposed in a seal groove that extends radially inwardly relative to the exterior surface of the first coupling section. In at least one embodiment, the seal is compressed longitudinally when the first groove engages the tongue. In at least one embodiment, the first sealing surface longitudinally compresses the seal against the second sealing surface when the first groove engages the tongue.

In at least one embodiment, a bottle can include an upper portion having a primary mouth and a first coupling section, and a lower portion having a closed base and a second coupling section. In at least one embodiment, the first coupling section can be configured to be removably coupled with the second coupling section for removably coupling the upper and lower portions of the bottle with one another. In at least one embodiment, the first coupling section can include an exterior surface, a tongue that extends radially outwardly relative to the exterior surface, a first sealing surface that extends around the exterior surface, the first sealing surface being disposed below the tongue, and a seal disposed adjacent the first sealing surface. In at least one embodiment, the second coupling section can include an interior surface, a first groove that extends radially outwardly from the interior surface, and a second sealing surface disposed below the first groove. In at least one embodiment, when the upper and lower portions of the bottle are coupled with one another, the first groove engages the tongue and the seal sealingly engages both sealing surfaces.

In at least one embodiment, the tongue can include a ramped or curved surface that increases in diameter from bottom to top. In at least one embodiment, the seal can be an elastically deformable sealing element disposed in a seal groove that extends radially inwardly relative to the exterior surface of the first coupling section. In at least one embodiment, the first sealing surface can include a second groove that extends radially inwardly relative to the exterior surface of the first coupling section. In at least one embodiment, the second sealing surface can include a third groove that extends radially outwardly relative to the interior surface of the second coupling section.

In at least one embodiment, the seal can be formed integrally with the first coupling section. In at least one embodiment, the seal can be compressed longitudinally when the first groove engages the tongue. In at least one embodiment, the first sealing surface longitudinally compresses the seal against the second sealing surface when the first groove engages the tongue.

A bottle according to the disclosure can be configured to hold any content or contents required or desired for an implementation of the disclosure, including but not limited to fluids and semi-fluids. Some of many examples of an implementation of the present disclosure include (but are by no means limited to) shampoo bottles, conditioner bottles, lotion bottles, oil bottles, soap bottles, condiment bottles, cleaning product bottles and bottles for virtually any other product or substance capable of being stored in or utilized from a bottle, specifically including, without limitation, products and substances that are susceptible to being at least partially wasted when stored in or utilized from conventional bottles. Further, a bottle according to the disclosure can be of any size or shape required or desired according to an implementation of the disclosure, including but not limited to having cross-sectional shapes that are circular, square, rectangular, triangular, oblong, irregular, polygonal or otherwise, separately or in combination, in whole or in part.

### BRIEF DESCRIPTION OF THE SEVERAL VIEWS OF THE DRAWINGS

FIG. 1 is a schematic perspective view of one of many embodiments of a bottle having separable portions (shown uncoupled) according to the disclosure.

FIG. 2 is a schematic perspective view of the bottle of FIG. 1 having separable portions (shown coupled) according to the disclosure.

FIG. 3 is a schematic perspective view of one of many embodiments of a bottle lower portion having couplers according to the disclosure.

FIG. 4 is a partial sectional exploded view of one of many embodiments of interlocking couplers according to the disclosure.

FIG. 5 is a close-up sectional view of one of many embodiments of a notch of a coupler in sealing engagement with a ridge of another coupler according to the disclosure.

FIG. 6 is a perspective view of another one of many embodiments of a bottle having separable portions (shown coupled) according to the disclosure.

FIG. 7 is a perspective partial view of the bottle of FIG. 6 having separable portions (shown uncoupled) according to the disclosure.

FIG. 8 is a partial sectional view of a top portion of the bottle of FIG. 6 according to the disclosure.

FIG. 9 is a partial sectional view of a bottom portion of the bottle of FIG. 6 according to the disclosure.

FIG. 10 is a close-up sectional view of couplers (shown partially engaged) of the bottle of FIG. 6 according to the disclosure.

FIG. 11 is a perspective view of another one of many embodiments of a bottle having separable portions (shown coupled) according to the disclosure.

FIG. 12 is a perspective partial view of the bottle of FIG. 11 having separable portions (shown uncoupled) according to the disclosure.

FIG. 13 is a perspective sectional view of the bottle of FIG. 11 having separable portions (shown uncoupled) according to the disclosure.

FIG. 14 is a close-up sectional view of couplers (shown partially engaged) of the bottle of FIG. 11 according to the disclosure.

FIG. 15 is a perspective view of another one of many embodiments of a bottle having hingedly separable portions (shown coupled) according to the disclosure.

FIG. 16 is a perspective partial view of the bottle of FIG. 15 having hingedly separable portions (shown uncoupled) according to the disclosure.

FIG. 17 is a perspective rear partial view of a hinge of the bottle of FIG. 15 having hingedly separable portions (shown coupled) according to the disclosure.

FIG. 18 is a partial sectional view of the bottle of FIG. 15 having hingedly separable portions (shown coupled) according to the disclosure.

FIG. 19 is a close-up sectional view of couplers (shown engaged) of the bottle of FIG. 15 according to the disclosure.

FIG. 20 is a close-up sectional view of a recess of the bottle of FIG. 15 according to the disclosure.

FIG. 21 is a perspective view of another one of many embodiments of a bottle having separable portions (shown coupled) according to the disclosure.

FIG. 22 is a perspective partial view of the bottle of FIG. 21 having separable portions (shown uncoupled) according to the disclosure.

FIG. 23 is a partial sectional view of the bottle of FIG. 21 having separable portions (shown partially coupled) according to the disclosure.

FIG. 24 is a partial sectional view of the bottle of FIG. 21 having separable portions (shown coupled) according to the disclosure.

FIG. 25 is a close-up sectional view of couplers (shown engaged) of the bottle of FIG. 21 according to the disclosure.

FIG. 26 is a perspective view of another one of many embodiments of a bottle having separable portions (shown coupled) according to the disclosure.

FIG. 27 is a perspective partial view of the bottle of FIG. 26 having separable portions (shown uncoupled) according to the disclosure.

FIG. 28 is a partial sectional view of the bottle of FIG. 26 having separable portions (shown partially coupled) according to the disclosure.

FIG. 29 is a close-up sectional view of couplers (shown engaged) of the bottle of FIG. 26 according to the disclosure.

FIG. 30 is a perspective view of another one of many embodiments of a bottle having separable portions (shown coupled) according to the disclosure.

FIG. 31 is a partial sectional view of the bottle of FIG. 30 having separable portions (shown uncoupled) according to the disclosure.

FIG. 32 is a close-up sectional view of couplers (shown engaged) of the bottle of FIG. 30 according to the disclosure.

FIG. 33 is a close-up sectional view of a top coupler of the bottle of FIG. 30 according to the disclosure.

FIG. 34 is a close-up sectional view of a bottom coupler of the bottle of FIG. 30 according to the disclosure.

FIG. 35 is a sectional view of couplers (shown engaged) of the bottle of FIG. 30 according to the disclosure.

FIG. 36 is a perspective view of another one of many embodiments of a bottle having separable portions (shown coupled) according to the disclosure.

FIG. 37 is a partial sectional view of the bottle of FIG. 36 having separable portions (shown uncoupled) according to the disclosure.

FIG. 38 is a close-up sectional view of couplers (shown engaged) of the bottle of FIG. 36 according to the disclosure.

FIG. 39 is a close-up sectional view of a top coupler of the bottle of FIG. 36 according to the disclosure.

FIG. 40 is a close-up sectional view of a bottom coupler of the bottle of FIG. 36 according to the disclosure.

FIG. 41 is a sectional view of couplers (shown engaged) of the bottle of FIG. 36 according to the disclosure.

FIG. 42A is a close-up sectional view of another one of many embodiments of couplers (shown engaged) of a bottle having separable portions (shown coupled) according to the disclosure.

FIG. 42B is a close-up sectional view of another one of many embodiments of couplers (shown engaged) of a bottle having separable portions (shown coupled) according to the disclosure.

FIG. 43 is an elevation view of another one of many embodiments of a bottle having separable portions (shown coupled) according to the disclosure.

FIG. 44 is a side elevation view of the bottle of FIG. 43 having separable portions (shown coupled) according to the disclosure.

FIG. 45 is a perspective view of the bottle of FIG. 43 having separable portions (shown coupled) according to the disclosure.

FIG. 46 is a bottom plan view of the bottle of FIG. 43 having separable portions (shown coupled) according to the disclosure.

FIG. 47 is a partial sectional view of a top portion of the bottle of FIG. 43 according to the disclosure.

FIG. 48 is a close-up sectional view of a top coupler of the bottle of FIG. 43 according to the disclosure.

FIG. 49 is a partial sectional view of a bottom portion of the bottle of FIG. 43 according to the disclosure.

FIG. 50 is a close-up sectional view of a bottom coupler of the bottle of FIG. 43 according to the disclosure.

FIG. 51 is a perspective partial view of the bottle of FIG. 43 having separable portions (shown uncoupled) according to the disclosure.

FIG. 52 is a partial sectional view of the bottle of FIG. 43 having separable portions (shown uncoupled) according to the disclosure.

### DETAILED DESCRIPTION OF THE INVENTION

The Figures described above and the written description of specific structures and functions below are not presented to limit the scope of what Applicant has invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms.

The use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the inventions or the appended claims. The terms “including” and “such as” are illustrative and not limitative. The terms “couple,” “coupled,” “coupling,” “coupler,” and like terms are used broadly herein and can include any method or device for securing, binding, bonding, fastening, attaching, joining, inserting therein, forming thereon or therein, communicating, or otherwise associating, for example, mechanically, magnetically, electrically, chemically, operably, directly or indirectly with intermediate elements, one or more pieces of members together and can further include without limitation integrally forming one functional member with another in a unity fashion. The coupling can occur in any direction, including rotationally. Further, all parts and components of the disclosure that are capable of being physically embodied inherently include imaginary and real characteristics regardless of whether such characteristics are expressly described herein, including but not limited to characteristics such as axes, ends, inner and outer surfaces, interior spaces, tops, bottoms, sides, boundaries, dimensions (e.g., height, length, width, thickness), mass, weight, volume and density, among others.

Applicant has created new and useful devices, systems and methods for facilitating utilization of the entirety of the contents of a bottle. A bottle can include an upper portion having a first coupling section, and a lower portion having a second coupling section. The first coupling section can be configured to be removably coupled with the second coupling section for removably coupling the upper and lower portions of the bottle with one another. One of the coupling sections can include a first groove, with the other one of the coupling sections including a tongue. When the upper and lower portions of the bottle are coupled with one another, the groove engages the tongue and the seal sealingly engages sealing surfaces of the upper and lower portions of the bottle.

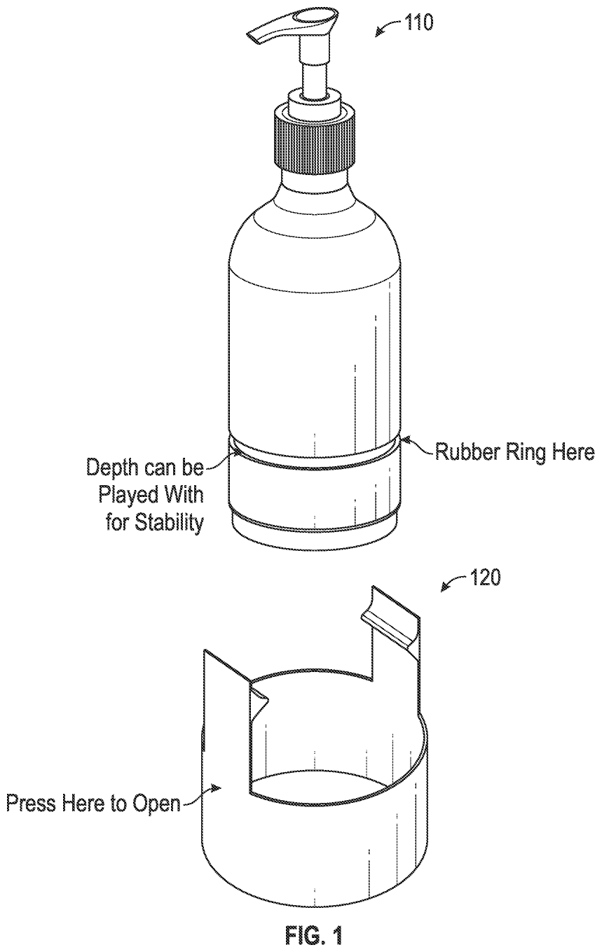

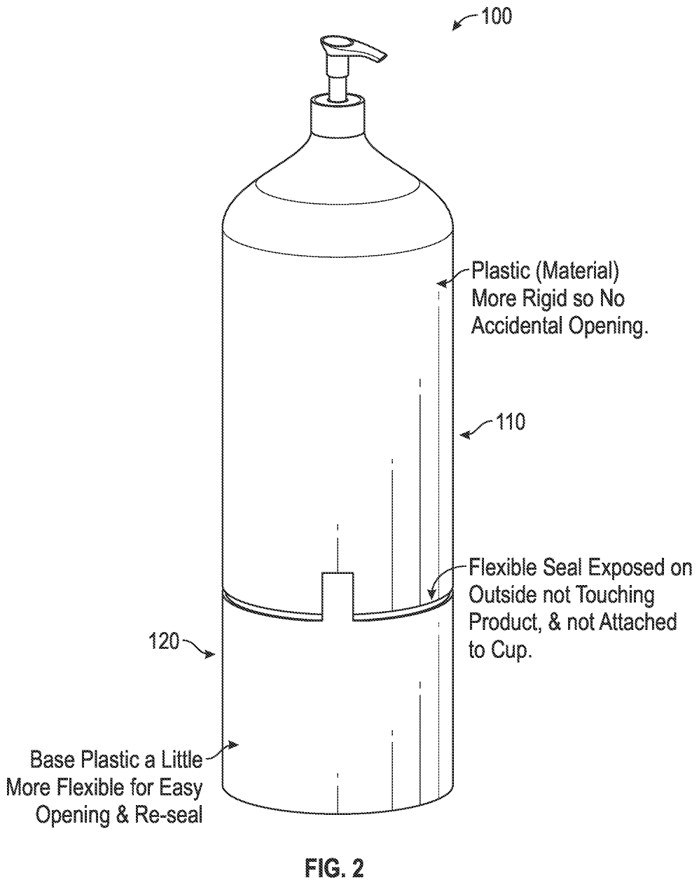

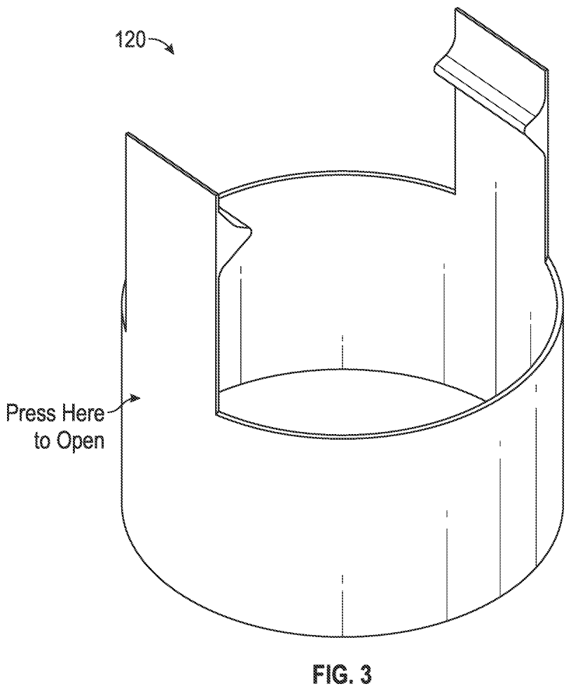

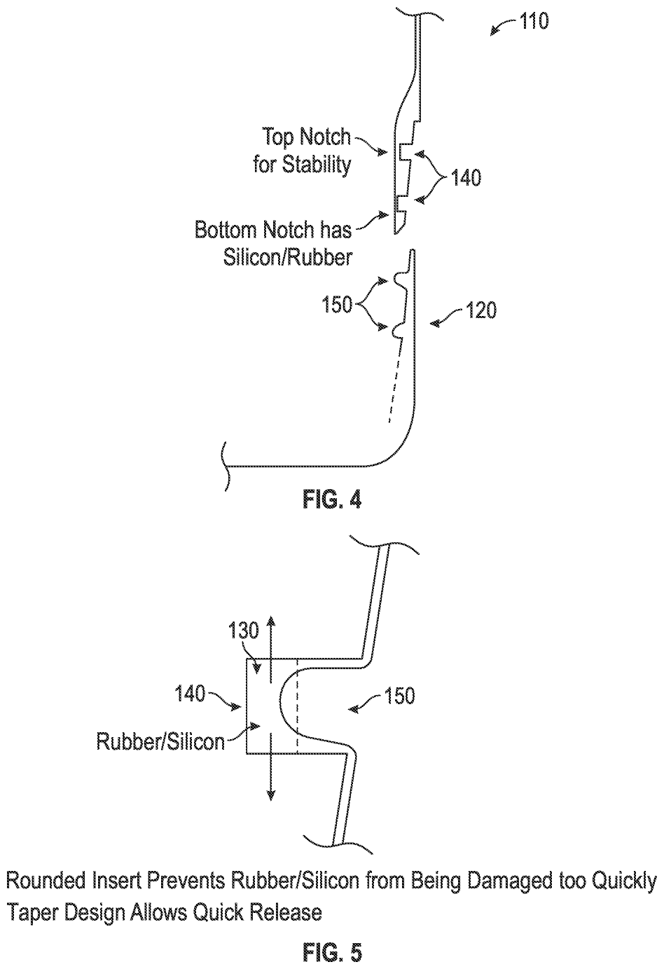

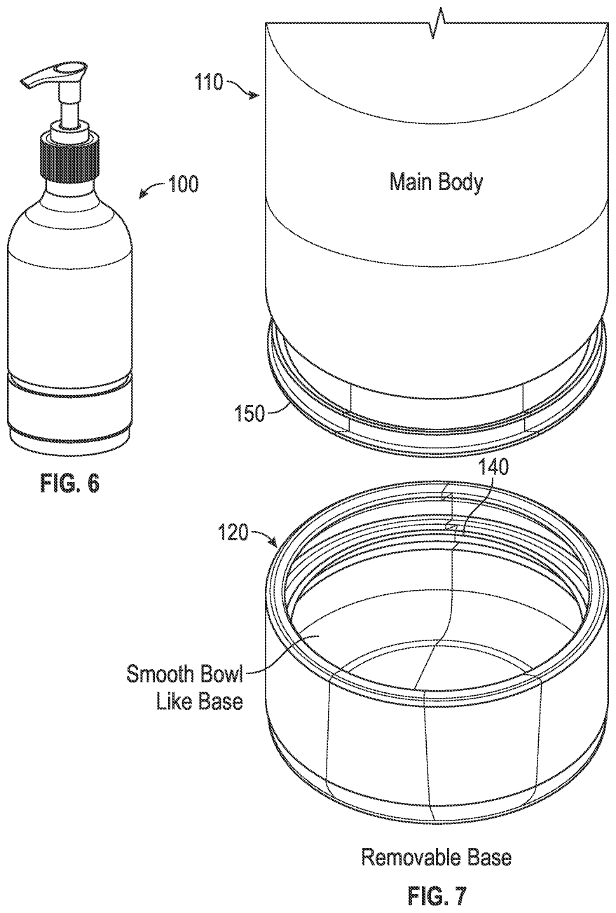

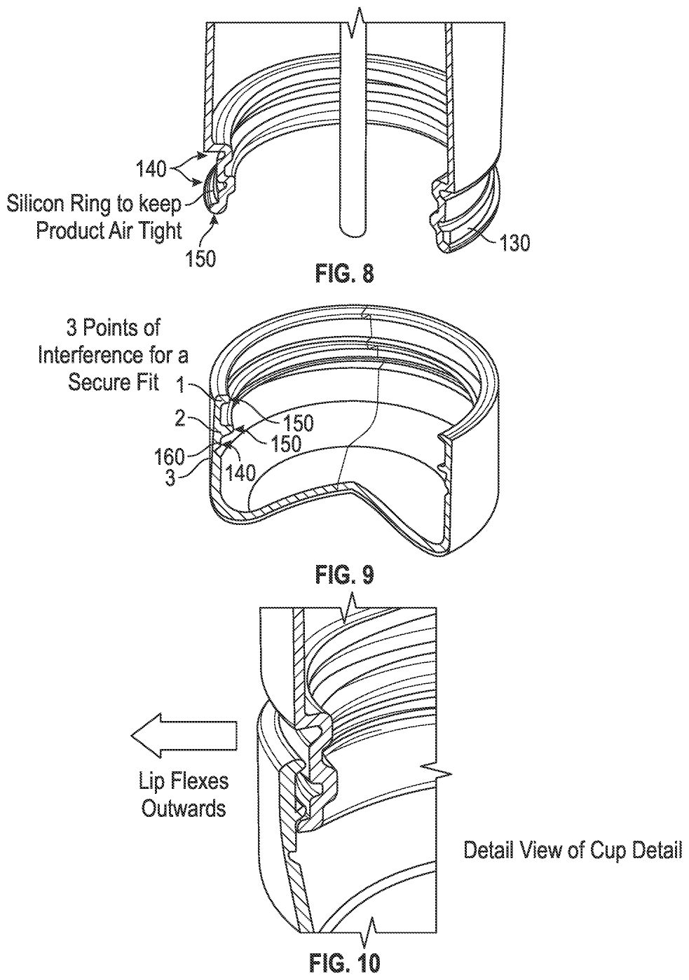

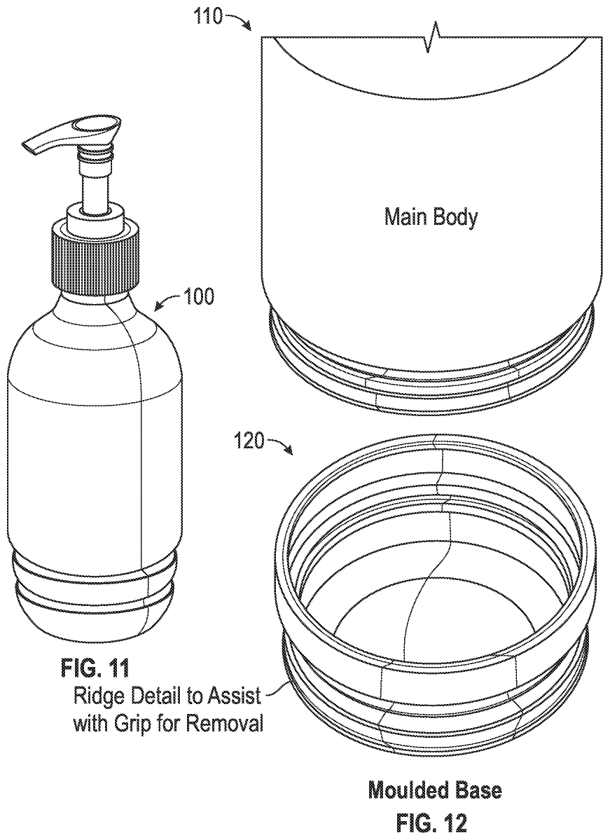

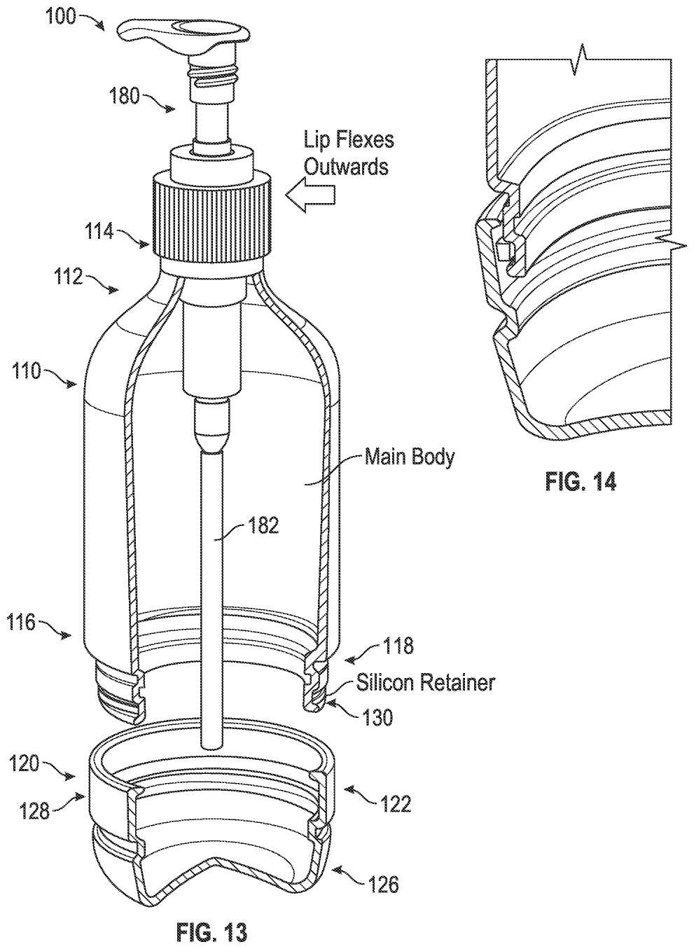

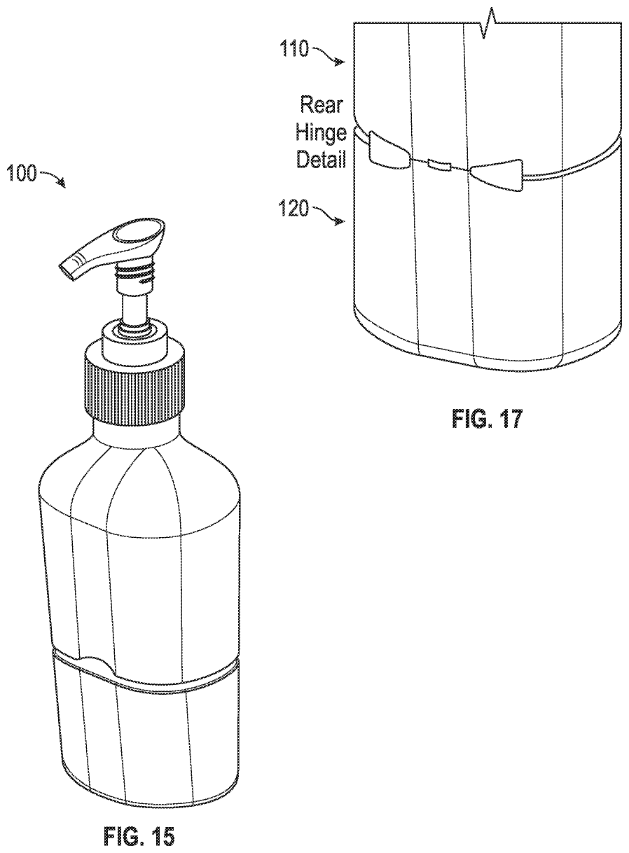

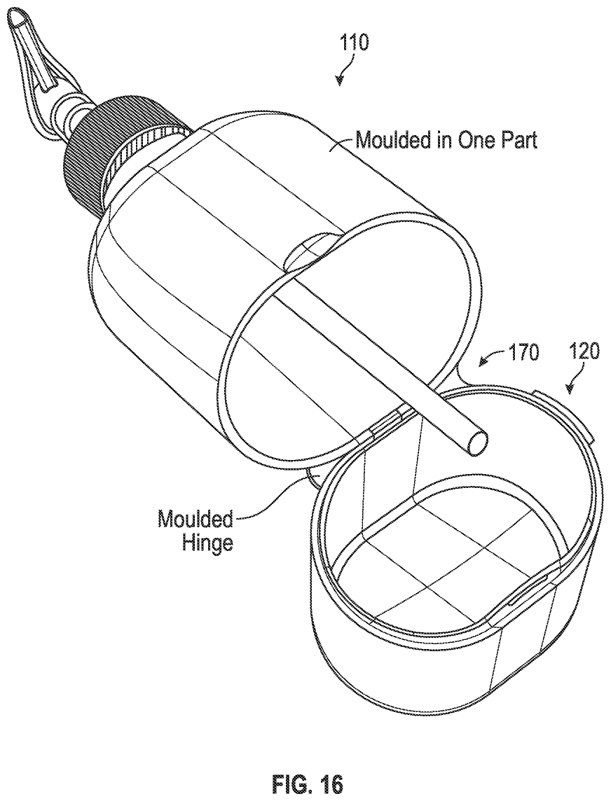

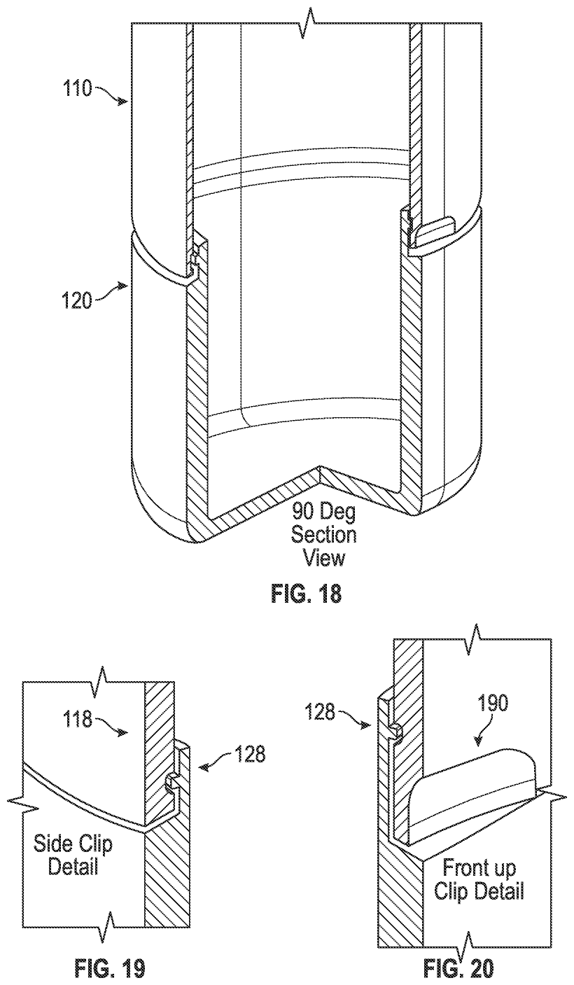

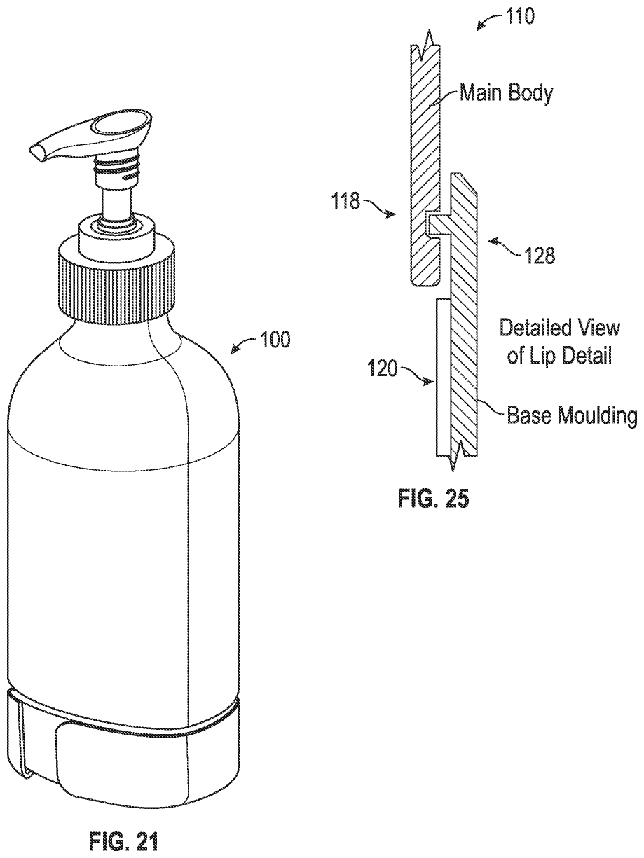

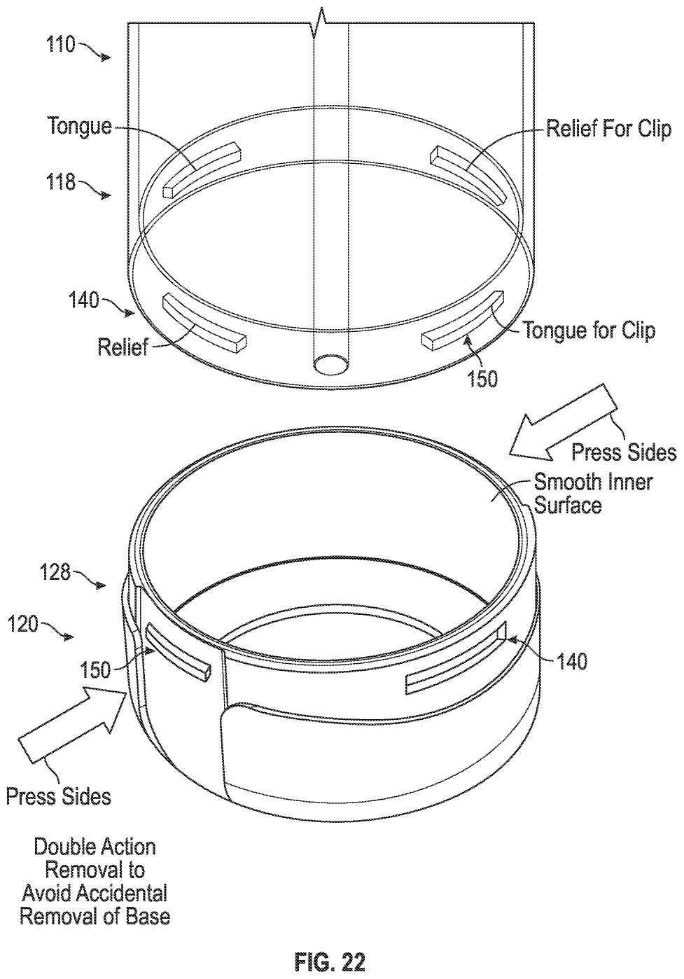

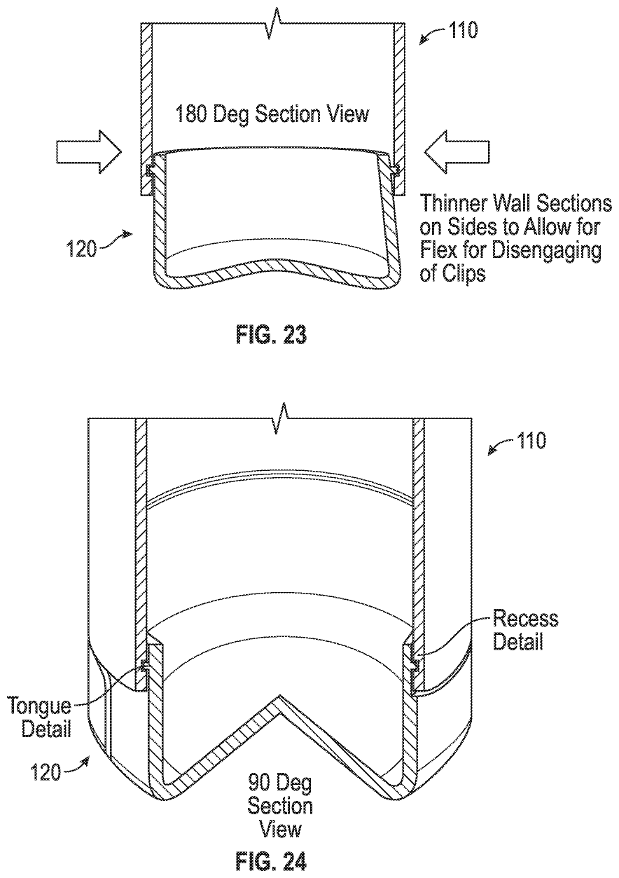

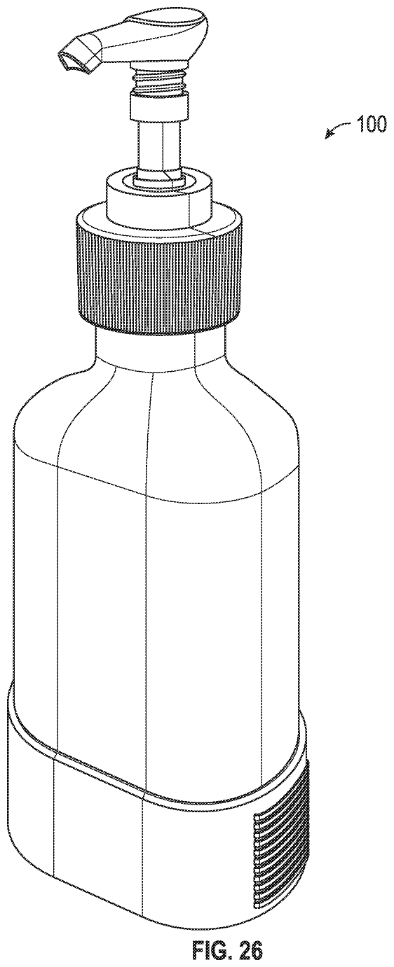

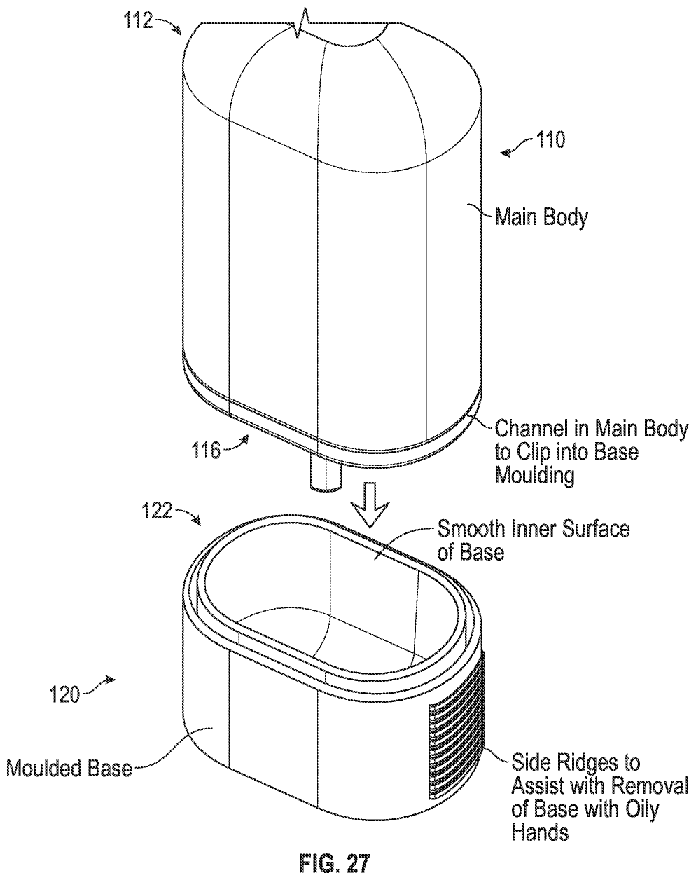

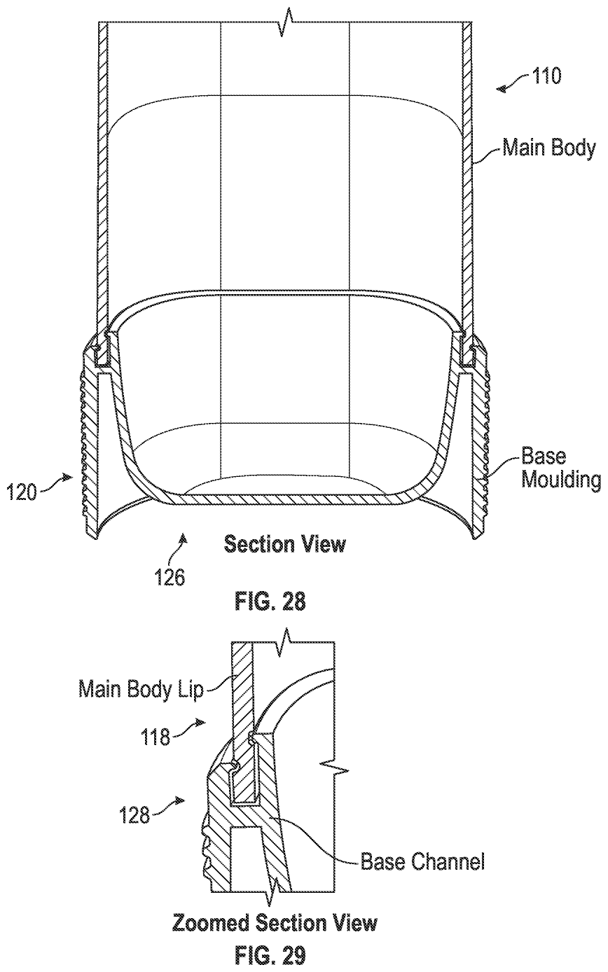

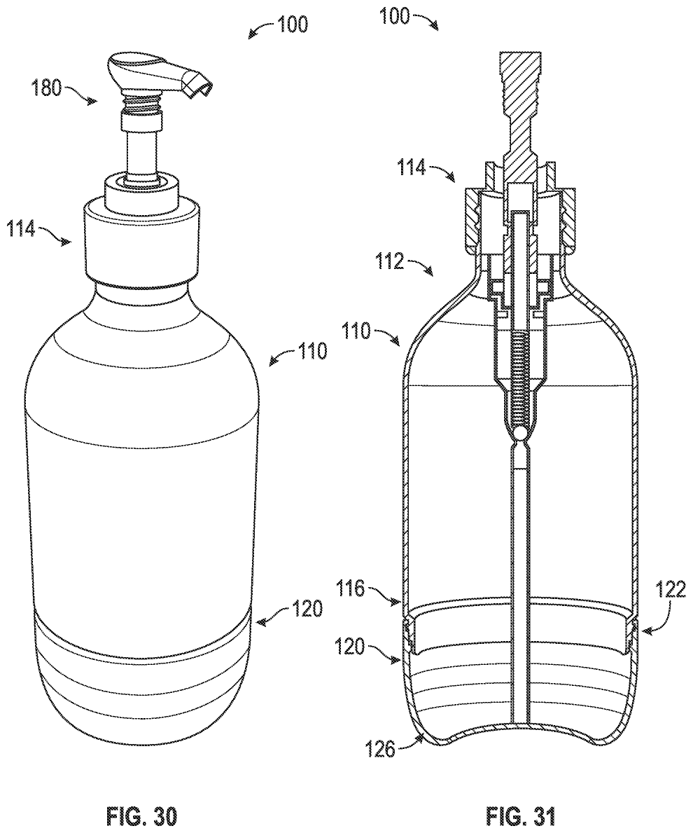

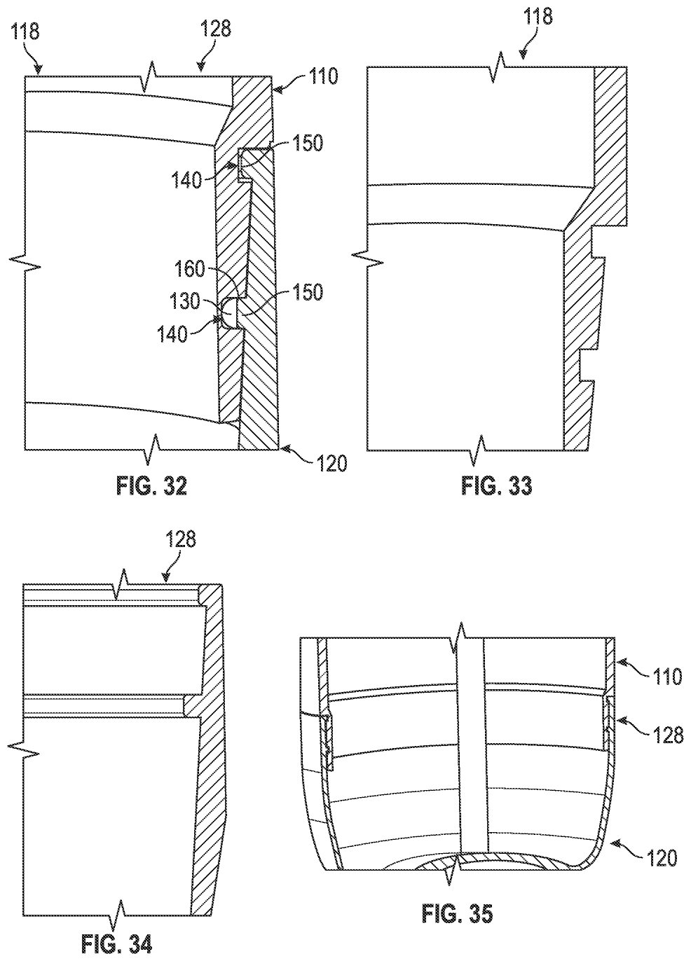

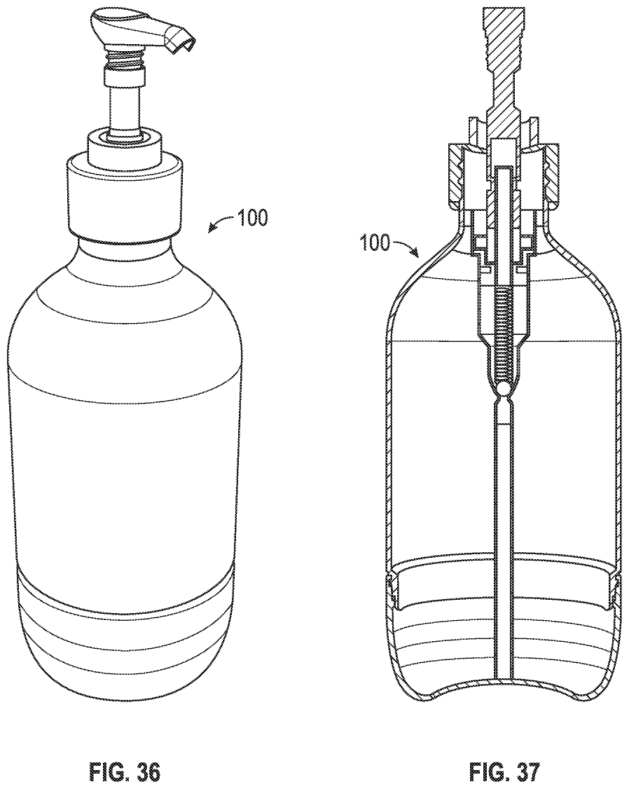

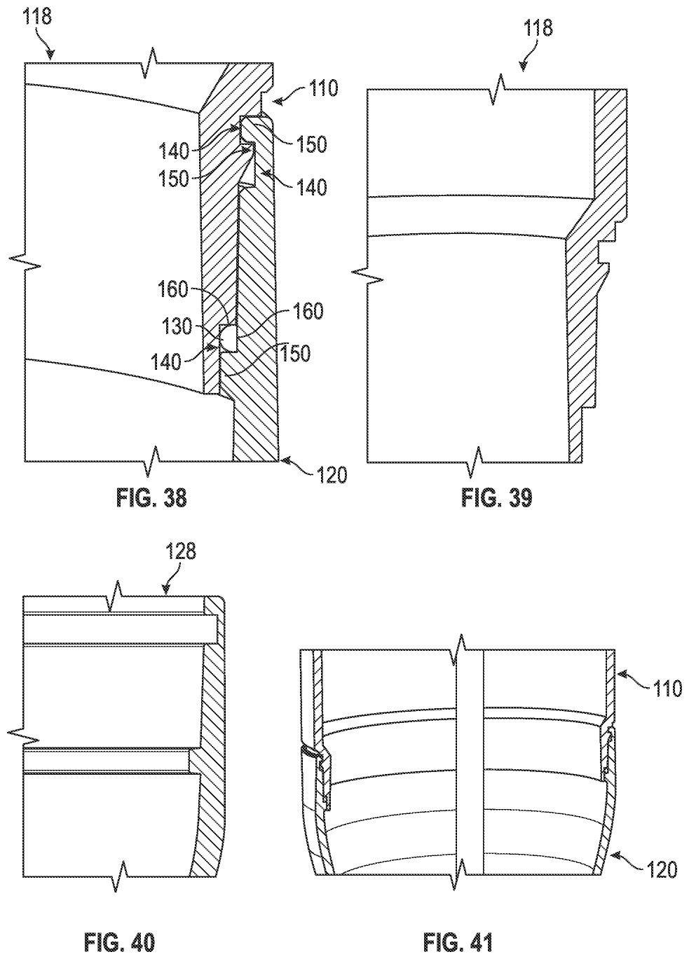

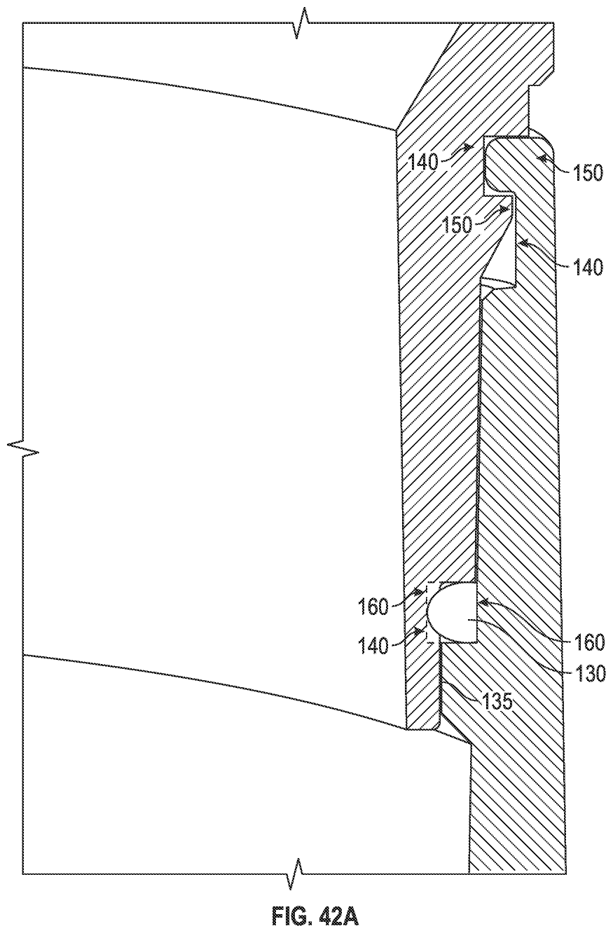

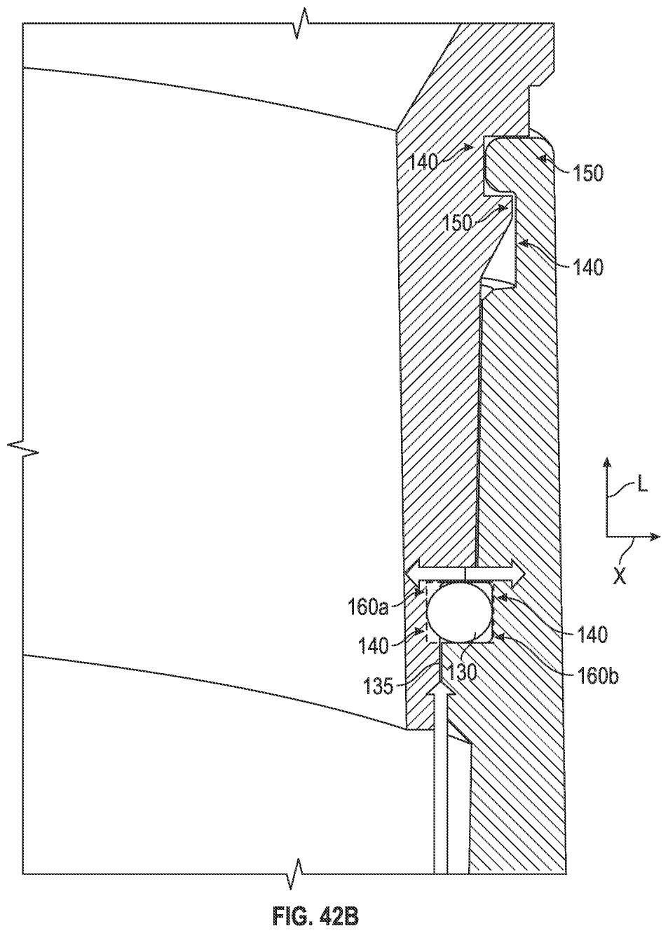

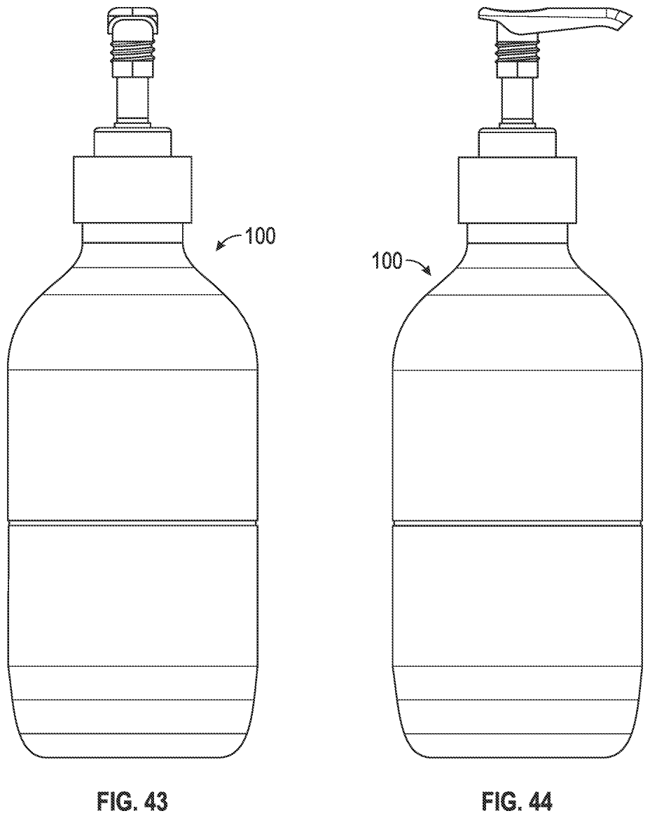

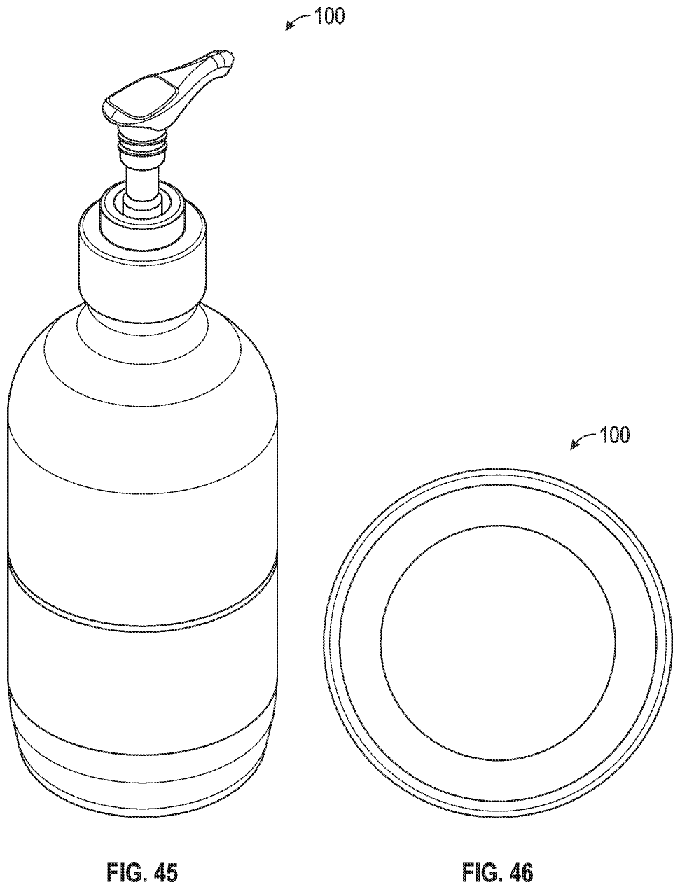

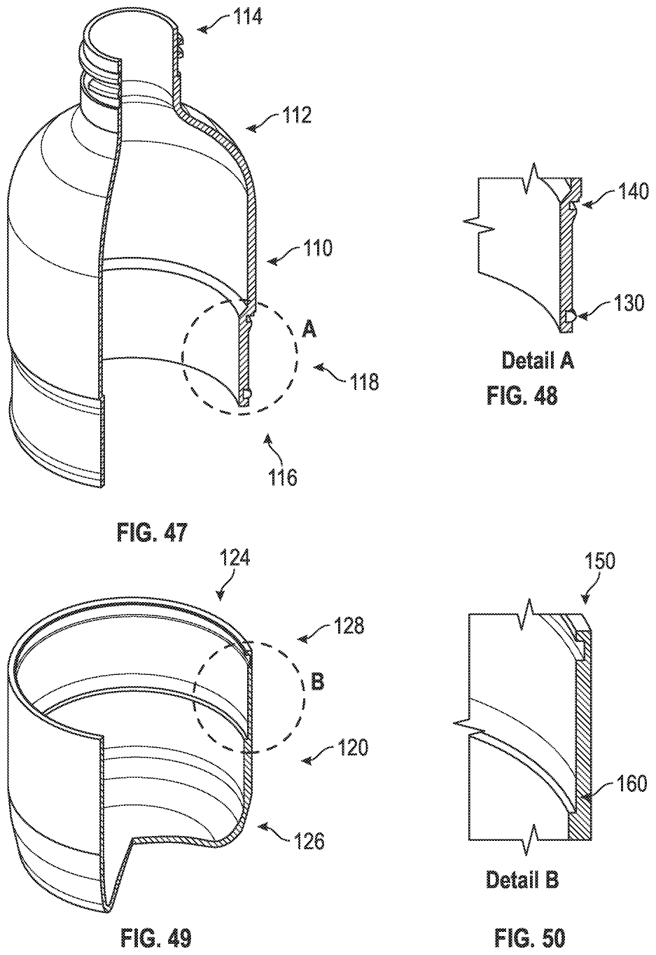

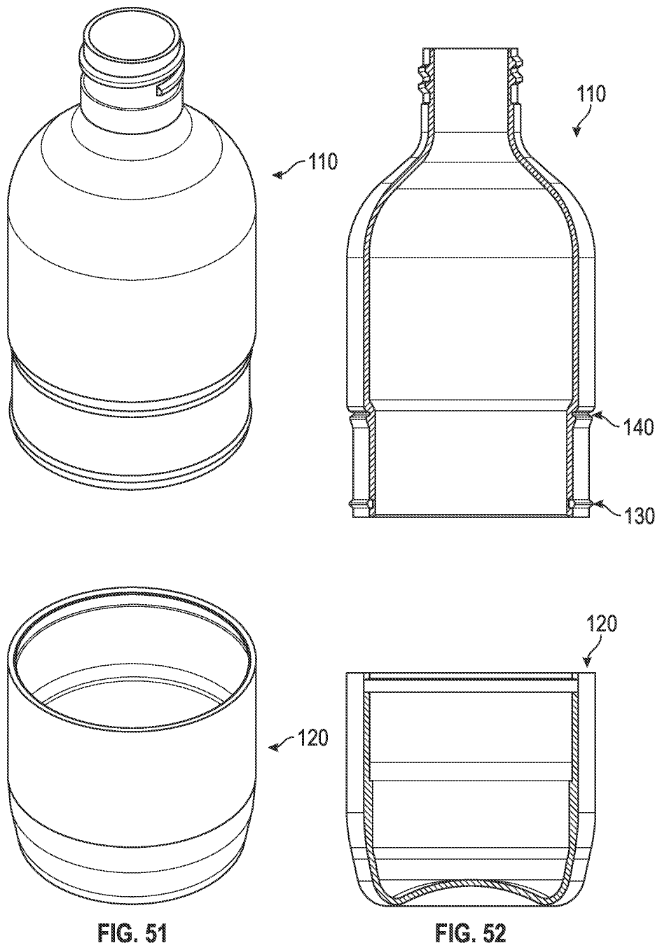

FIG. 1 is a schematic perspective view of one of many embodiments of a bottle having separable portions (shown uncoupled) according to the disclosure. FIG. 2 is a schematic perspective view of one of many embodiments of the bottle of FIG. 1 having separable portions (shown coupled) according to the disclosure. FIG. 3 is a schematic perspective view of one of many embodiments of a bottle lower portion having couplers according to the disclosure. FIG. 4 is a partial sectional exploded view of one of many embodiments of interlocking couplers according to the disclosure. FIG. 5 is a close-up sectional view of one of many embodiments of a notch of a coupler in sealing engagement with a ridge of another coupler according to the disclosure. FIG. 6 is a perspective view of another one of many embodiments of a bottle having separable portions (shown coupled) according to the disclosure. FIG. 7 is a perspective partial view of the bottle of FIG. 6 having separable portions (shown uncoupled) according to the disclosure. FIG. 8 is a partial sectional view of a top portion of the bottle of FIG. 6 according to the disclosure. FIG. 9 is a partial sectional view of a bottom portion of the bottle of FIG. 6 according to the disclosure. FIG. 10 is a close-up sectional view of couplers (shown partially engaged) of the bottle of FIG. 6 according to the disclosure. FIG. 11 is a perspective view of another one of many embodiments of a bottle having separable portions (shown coupled) according to the disclosure. FIG. 12 is a perspective partial view of the bottle of FIG. 11 having separable portions (shown uncoupled) according to the disclosure. FIG. 13 is a perspective sectional view of the bottle of FIG. 11 having separable portions (shown uncoupled) according to the disclosure. FIG. 14 is a close-up sectional view of couplers (shown partially engaged) of the bottle of FIG. 11 according to the disclosure. FIG. 15 is a perspective view of another one of many embodiments of a bottle having hingedly separable portions (shown coupled) according to the disclosure. FIG. 16 is a perspective partial view of the bottle of FIG. 15 having hingedly separable portions (shown uncoupled) according to the disclosure. FIG. 17 is a perspective rear partial view of a hinge of the bottle of FIG. 15 having hingedly separable portions (shown coupled) according to the disclosure. FIG. 18 is a partial sectional view of the bottle of FIG. 15 having hingedly separable portions (shown coupled) according to the disclosure. FIG. 19 is a close-up sectional view of couplers (shown engaged) of the bottle of FIG. 15 according to the disclosure. FIG. 20 is a close-up sectional view of a recess of the bottle of FIG. 15 according to the disclosure. FIG. 21 is a perspective view of another one of many embodiments of a bottle having separable portions (shown coupled) according to the disclosure. FIG. 22 is a perspective partial view of the bottle of FIG. 21 having separable portions (shown uncoupled) according to the disclosure. FIG. 23 is a partial sectional view of the bottle of FIG. 21 having separable portions (shown partially coupled) according to the disclosure. FIG. 24 is a partial sectional view of the bottle of FIG. 21 having separable portions (shown coupled) according to the disclosure. FIG. 25 is a close-up sectional view of couplers (shown engaged) of the bottle of FIG. 21 according to the disclosure. FIG. 26 is a perspective view of another one of many embodiments of a bottle having separable portions (shown coupled) according to the disclosure. FIG. 27 is a perspective partial view of the bottle of FIG. 26 having separable portions (shown uncoupled) according to the disclosure. FIG. 28 is a partial sectional view of the bottle of FIG. 26 having separable portions (shown partially coupled) according to the disclosure. FIG. 29 is a close-up sectional view of couplers (shown engaged) of the bottle of FIG. 26 according to the disclosure. FIG. 30 is a perspective view of another one of many embodiments of a bottle having separable portions (shown coupled) according to the disclosure. FIG. 31 is a partial sectional view of the bottle of FIG. 30 having separable portions (shown uncoupled) according to the disclosure. FIG. 32 is a close-up sectional view of couplers (shown engaged) of the bottle of FIG. 30 according to the disclosure. FIG. 33 is a close-up sectional view of a top coupler of the bottle of FIG. 30 according to the disclosure. FIG. 34 is a close-up sectional view of a bottom coupler of the bottle of FIG. 30 according to the disclosure. FIG. 35 is a sectional view of couplers (shown engaged) of the bottle of FIG. 30 according to the disclosure. FIG. 36 is a perspective view of another one of many embodiments of a bottle having separable portions (shown coupled) according to the disclosure. FIG. 37 is a partial sectional view of the bottle of FIG. 36 having separable portions (shown uncoupled) according to the disclosure. FIG. 38 is a close-up sectional view of couplers (shown engaged) of the bottle of FIG. 36 according to the disclosure. FIG. 39 is a close-up sectional view of a top coupler of the bottle of FIG. 36 according to the disclosure. FIG. 40 is a close-up sectional view of a bottom coupler of the bottle of FIG. 36 according to the disclosure. FIG. 41 is a sectional view of couplers (shown engaged) of the bottle of FIG. 36 according to the disclosure. FIG. 42A is a close-up sectional view of another one of many embodiments of couplers (shown engaged) of a bottle having separable portions (shown coupled) according to the disclosure. FIG. 42B is a close-up sectional view of another one of many embodiments of couplers (shown engaged) of a bottle having separable portions (shown coupled) according to the disclosure. FIG. 43 is an elevation view of another one of many embodiments of a bottle having separable portions (shown coupled) according to the disclosure. FIG. 44 is a side elevation view of the bottle of FIG. 43 having separable portions (shown coupled) according to the disclosure. FIG. 45 is a perspective view of the bottle of FIG. 43 having separable portions (shown coupled) according to the disclosure. FIG. 46 is a bottom plan view of the bottle of FIG. 43 having separable portions (shown coupled) according to the disclosure. FIG. 47 is a partial sectional view of a top portion of the bottle of FIG. 43 according to the disclosure. FIG. 48 is a close-up sectional view of a top coupler of the bottle of FIG. 43 according to the disclosure. FIG. 49 is a partial sectional view of a bottom portion of the bottle of FIG. 43 according to the disclosure. FIG. 50 is a close-up sectional view of a bottom coupler of the bottle of FIG. 43 according to the disclosure. FIG. 51 is a perspective partial view of the bottle of FIG. 43 having separable portions (shown uncoupled) according to the disclosure. FIG. 52 is a partial sectional view of the bottle of FIG. 43 having separable portions (shown uncoupled) according to the disclosure. FIGS. 1-52 are described in conjunction with one another.

In at least one embodiment, a bottle 100 can include an upper portion 110 having a primary mouth 114 and a first coupling section 118, and a lower portion 120 having a closed base 126, a secondary mouth 122 and a second coupling section 128. In at least one embodiment, the first coupling section 118 can be configured to be disposed at least partially through the secondary mouth 122 and removably coupled with the second coupling section 118 for removably coupling the upper and lower portions of the bottle 100 with one another. In at least one embodiment, the first coupling section 118 can include an exterior surface, a first groove 140 that extends radially inwardly relative to the exterior surface, a first tongue 150 that extends radially outwardly from the exterior surface, the first tongue 150 being disposed below the first groove 140, a seal 130 that extends radially outwardly relative to the exterior surface, the seal 130 being disposed below the first tongue 150, and a downwardly facing rim 165. In at least one embodiment, the second coupling section 128 can include an interior surface and an exterior surface, a second tongue 150 that extends radially inwardly from the exterior surface, a second groove 140 that extends radially outwardly from the interior surface, the second groove 140 being disposed below the second tongue 150, a sealing surface 160 disposed below the second groove 140, and an upwardly facing rim 165. In at least one embodiment, when the upper and lower portions of the bottle 100 are coupled with one another, the first groove 140 engages the second tongue 150, the first tongue 150 engages the second groove 140, and the seal 130 sealingly engages one or more sealing surfaces 160, which can include a downwardly facing rim 165 and an upwardly facing rim 165.

In at least one embodiment, the primary mouth 114 can be smaller than the secondary mouth 122. In at least one embodiment, the first tongue 150 can be or include a ramped or curved surface that increases in diameter from bottom to top. In at least one embodiment, the first tongue 150 can intersect a wall of the first groove 140.

In at least one embodiment, the seal 130 can be formed integrally with the first coupling section 118. In at least one embodiment, the seal 130 can be an elastically deformable sealing element disposed in a seal groove 140 that extends radially inwardly relative to the exterior surface of the first coupling section 118.

In at least one embodiment, a bottle 100, such as an at least partially plastic bottle, can include two or more at least partially separable portions for allowing a user to readily access the interior and/or contents of the bottle. For example, first and second bottle portions can be configured to be openable or optionally uncoupled from one another for facilitating removal of the remaining contents of the bottle 100 once the primary removal means (e.g., squeezing or pumping) becomes ineffective or impractical, such as due to a relatively small amount of contents remaining in the bottle (or otherwise).

In at least one embodiment, a bottle 100 can include an upper portion 110 having a top end 112 with a mouth 114 and a longitudinally opposite bottom end 116, and a lower portion 120 having a top end 122 and a longitudinally opposite closed base 126, wherein the bottom end 116 of the upper portion 110 and the top end 122 of the lower portion 120 are open, and wherein the bottom end 116 of the upper portion 110 and the top end 122 of the lower portion 120 are configured to be removably and sealingly coupled with one another. The bottom end 116 of the upper portion 110 can include a neck, such as a recessed neck, which can have an exterior surface, such as a radially, perimetrically, perimetrally or other exterior surface. The top end 122 of the lower portion 120 can include an interior surface, such as a radially, perimetrically, perimetrally or other interior surface. The exterior surface of the neck and the interior surface of the lower portion 110 can be configured to sealingly engage one another. One or more seals 130 can be disposed on the exterior surface of the neck, interior surface of the lower portion 120, or otherwise disposed for supporting sealing engagement between two or more bottle portions 110,120.

In at least one embodiment, a bottle 100 can include a plurality of male couplers coupled to one of the upper and lower portions 110,120 and a plurality of female couplers coupled to the other of the upper and lower portions 110,120. The plurality of male couplers can be configured to releasably couple with the plurality of female couplers. In at least one embodiment, one or more bottle portions can have a single coupler. In at least one embodiment, one or more bottle portions can have one or more male couplers and one or more female couplers. One or more couplers can be or include any type of coupler for supporting removable coupling of two or more bottle portions according to an implementation of the disclosure. Examples of suitable couplers include flexible snap-fit or interference fit couplers as shown in the figures for illustrative purposes, among many others, such as threads, tongue and groove couplers, hook and groove couplers, and other couplers capable of being integrally formed with or otherwise coupled to one or more bottle portions. In at least one embodiment, the couplers can be absent and two or more bottle portions can be configured to couple with one another via interference fit or otherwise.

In at least one embodiment, a bottle 100 can include one or more notches, channels, or grooves 140 around an inner and/or outer surface of a male coupler of a top portion 110 of the bottle 100 that selectively interlock, or engage, one or more ridges, flanges, tongues, or protrusions 150 around an inner and/or outer surface of a female coupler of a bottom portion 120 of the bottle 100. In at least one embodiment, a bottle 100 can include one or more notches, channels, or grooves 1400 around an inner and/or outer surface of a male coupler of a bottom portion 120 of the bottle 100 that selectively interlock, or engage, one or more ridges, flanges, tongues, or protrusions 150 around an inner and/or outer surface of a female coupler of a top portion 110 of the bottle 110. In at least one embodiment, a bottle 100 can include one or more notches, channels, or grooves 140 around an inner and/or outer surface of a female coupler of a top portion 110 of the bottle 100 that selectively interlock, or engage, one or more ridges, flanges, tongues, or protrusions 150 around an outer surface of a male coupler of a bottom portion 120 of the bottle 100. In at least one embodiment, a bottle 100 can include one or more notches, channels, or grooves 140 around an inner and/or outer surface of a female coupler of a bottom portion 120 of the bottle 100 that selectively interlock, or engage, one or more ridges, flanges, tongues, or protrusions 150 around an outer surface of a male coupler of a top portion 110 of the bottle 100. The surfaces of the couplers can be tapered to aid in the manufacturing, or molding, process and/or coupling and decoupling the portions of the bottle. In at least one embodiment, the couplers can include both notches, channels, or grooves 140 and ridges, flanges, tongues, or protrusions 150 to ensure a secure fit between the portions of the bottle 100.

In at least one embodiment, a bottle 100 can include one or more seals 130, such as a rubber or other elastomeric seal, and one or more seals 130 can be sized and arranged for being fluidically isolated from an interior volume of the bottle 100. For example, a seal 130 can be coupled to at least one bottle portion and can be fluidically isolated from the interior of the bottle 100 when two bottle portions are coupled together, which can be advantageous, for instance, in implementations of the disclosure wherein the seal or seal material could negatively affect the contents of the bottle or vice versa. The one or more seals 130 can be retained within one or more of the notches, channels, or grooves, 140 or can be outside the grooves on another surface of the couplers. Any one or more of the notches, channels, or grooves 130 can include an elastomeric seal, such as silicone or rubber, to seal the contents within the bottle 100.

In at least one embodiment, each of the notches, channels, or grooves 140 can include an elastomeric seal 130 to sealingly engage with a corresponding one of the ridges, flanges, tongues, or protrusions 150. In at least one embodiment, one of the notches, channels, or grooves 140 includes an elastomeric seal 130 to sealingly engage with a corresponding one of the ridges, flanges, tongues, or protrusions 150 and another one of the notches, channels, or grooves 130 does not include an elastomeric seal 130 but rather engages with a corresponding one of the ridges, flanges, tongues, or protrusions 150 to ensure a secure fit between the portions of the bottle 100. In at least one embodiment, one of the notches, channels, or grooves 140 includes an elastomeric seal 130 to sealingly engage with a flat surface of the bottle 100.

In at least one embodiment, a bottle 100 can include an upper portion 110 having a primary mouth 114 and a first coupling section 118, and a lower portion 120 having a closed base 126 and a second coupling section 128. In at least one embodiment, the first coupling section 118 can be configured to be removably coupled with the second coupling section 128 for removably coupling the upper and lower portions 110,120 of the bottle 100 with one another. In at least one embodiment, the first coupling section 118 can include an exterior surface, a first groove 140 that extends radially inwardly relative to the exterior surface, a first sealing surface 160 that extends around the exterior surface, the first sealing surface 160 being disposed below the first groove 140, and a seal 130 disposed adjacent the first sealing surface 160. In at least one embodiment, the second coupling section 128 can include an interior surface, a tongue 150 that extends radially inwardly from the interior surface, and a second sealing surface 160 disposed below the tongue 150. In at least one embodiment, when the upper and lower portions of the bottle 100 are coupled with one another, the first groove 140 engages the tongue 150 and the seal 130 sealingly engages both sealing surfaces 160.

In at least one embodiment, a lower wall of the first groove 140 can include a ramped or curved surface that increases in diameter from bottom to top. In at least one embodiment, the first sealing surface 160 can include a second groove 140 that extends radially inwardly relative to the exterior surface of the first coupling section 118. In at least one embodiment, the second sealing surface 160 can include a third groove 140 that extends radially outwardly relative to the interior surface of the second coupling section 128.

In at least one embodiment, the seal 130 can be formed integrally with the first coupling section 118 or the second coupling section 128. In at least one embodiment, the seal 130 can be an elastically deformable sealing element disposed in a seal groove 140 that extends radially inwardly relative to the exterior surface of the first coupling section 118 or the second coupling section 128. In at least one embodiment, the seal 130 is compressed longitudinally when the first groove 140 engages the tongue 150. In at least one embodiment, the first sealing surface 160 longitudinally compresses the seal 130 against the second sealing surface 160 when the first groove 140 engages the tongue 150. For example, when the first groove 140 engages the tongue 150, a portion of a first sealing surface 160a can compress the seal 130 along the longitudinal Y axis against a portion of the second sealing surface 160b, which in turn causes the seal 130 to expand along the latitudinal X axis, thereby sealing the junction of the first coupling section 118 or the second coupling section 128

In at least one embodiment, a bottle 100 can include an upper portion 110 having a primary mouth 114 and a first coupling section 118, and a lower portion 120 having a closed base 126 and a second coupling section 128. In at least one embodiment, the first coupling section 118 can be configured to be removably coupled with the second coupling section 128 for removably coupling the upper and lower portions of the bottle 100 with one another. In at least one embodiment, the first coupling section 118 can include an exterior surface, a tongue 150 that extends radially outwardly relative to the exterior surface, a first sealing surface 160 that extends around the exterior surface, the first sealing surface 160 being disposed below the tongue 150, and a seal 130 disposed adjacent the first sealing surface 160. In at least one embodiment, the second coupling section 128 can include an interior surface, a first groove 140 that extends radially outwardly from the interior surface, and a second sealing surface 160 disposed below the first groove 140. In at least one embodiment, when the upper and lower portions of the bottle 100 are coupled with one another, the first groove 140 engages the tongue 150 and the seal 130 sealingly engages both sealing surfaces 160.

In at least one embodiment, the tongue 150 can include a ramped or curved surface that increases in diameter from bottom to top. In at least one embodiment, the seal 130 can be an elastically deformable sealing element disposed in a seal groove 140 that extends radially inwardly relative to the exterior surface of the first coupling section 118 or the second coupling section 128. In at least one embodiment, the first sealing surface 160 can include a second groove 140 that extends radially inwardly relative to the exterior surface of the first coupling section 118. In at least one embodiment, the second sealing surface 160 can include a third groove 140 that extends radially outwardly relative to the interior surface of the second coupling section 128.

In at least one embodiment, the seal 130 can be formed integrally with the first coupling section 118 or the second coupling section 128. In at least one embodiment, the seal 130 can be compressed longitudinally when the first groove 140 engages the tongue 150. In at least one embodiment, the first sealing surface 160 longitudinally compresses the seal 130 against the second sealing surface 160 when the first groove 140 engages the tongue 150. In at least one embodiment, one or more surfaces of bottle portions 110, 120 can be disposed against or near one another and an intersection or junction 135 (see, e.g., FIGS. 42A-42B) can provide for a potential fluid path or leakage path for contents of bottle 100. In such an embodiment, which is but one of many, one or more grooves 140 and/or sealing surfaces 160 can advantageously be configured for allowing or otherwise supporting a seal 130 to be compressed and disposed in a manner such that seal 130 sealingly engages bottle surfaces on each side of junction 135 for at least partially optimizing the stoppage of fluid flow thereby. For example, in at least one embodiment, junction 135 and seal 130 can meet at a T intersection and seal 130 can be in sealing engagement with sealing surfaces on each side of function 135.

In at least one embodiment, a bottle 100 can include a hand pump 180 coupled to the mouth 114 and a feed tube 182 having a first end coupled to the hand pump 180 and a second end disposed within the bottle 100. The bottle 100 can be configured so that the upper and lower portions can be uncoupled from one another, such as for gaining access to contents of the bottle 100 that either have not been removed or cannot be removed via the hand pump 180 and feed tube 182. In at least one embodiment, the mouth 114 of the upper portion 110 of a bottle 100 can be or include a first mouth and the top end 122 of the lower portion 120 of the bottle 100 can be or include a second mouth disposed vertically beneath the first mouth.

In at least one embodiment, a bottle 100 can include an upper portion 110 and a lower portion 120 made from different materials. In at least one embodiment, one of the upper and lower portions of a bottle 100 can be made from a more rigid material than the other of the upper and lower portions, which can facilitate coupling and/or uncoupling of the bottle portions. In at least one embodiment, one of the upper and lower portions of a bottle 100 can be made from a thinner material than the other of the upper and lower portions, which can facilitate coupling and/or uncoupling of the bottle portions. In at least one embodiment, a bottle 100 can include notches, channels, or grooves 140 and/or ridges, flanges, tongues, or protrusions 150 on other surfaces of the bottle 100 to ensure a secure grip when coupling and/or decoupling the portions of the bottle 100.

In at least one embodiment, a bottle 100 can include an upper portion 110 hingedly secured to a lower portion 120, such as by hinge 170. The bottle 100 can also include the various notches, channels, grooves, ridges, flanges, tongues, protrusions, and/or seals described elsewhere. In at least one embodiment, a bottle 100 can also include one or more finger or other recesses 190 to assist in separating the upper portion 110 from the lower portion 120. The various notches, channels, grooves, ridges, flanges, tongues, protrusions described herein can be continuous around the bottle, and/or intermittently dispersed around the bottle. The various notches, channels, grooves, ridges, flanges, tongues, protrusions described herein can be spirally disposed around the bottle, and thereby form threads to selectively couple and/or decouple the portions of the bottle.

As can be seen the figures, either coupling section can be male or female, such that the coupling section of the upper portion can fit within the coupling section of the lower portion or the coupling section of the lower portion can fit within the coupling section of the upper portion. As can also be seen in the figures, either coupling section can include one or more tongues and/or one or more grooves, and these tongue(s) and/or groove(s) can be formed on an interior surface and/or an exterior surface of the respective coupling section.

In at least one embodiment, either or both coupling sections can be thicker and or stiffer than the rest of the upper and/or lower portions of bottle 100. The coupling sections can be formed integrally with the rest of the upper and/or lower portions of bottle 100. For example, in at least one embodiment, the coupling sections can be integrally molded with the rest of the upper and/or lower portions. In at least one embodiment, the coupling sections can be separately formed, e.g., molded, and then attached to the rest of the upper and/or lower portions, such as by plastic welding or melting together, for example.

As can be seen the figures, the seal 130 can be an O-ring and/or a belt, such as those made of rubber or silicone. In at least one embodiment, the seal 130 can be integral to the upper and/or lower portions 110, 120, such as by being formed thereon. In at least one embodiment, the seal 130 can be stuck on, melted on, shrunk upon, or any combination thereof, either the upper and/or lower portions. In at least one embodiment, the seal 130 can comprise multiple seals on either the upper and/or lower portions. In at least one embodiment, the seal 130 can comprise one or more seals on each of the upper and lower portions. In at least one embodiment, a seal 130 can reside in one or more of the grooves 140, and sealing engage the corresponding the tongue 150. In at least one embodiment, the seal 130 can form a tongue 150 and sealingly engage a groove 140. In at least one embodiment, the seal 130 can help guard against leakage/unintended separation of bottle portions during use until user intentionally separates the bottle portions to get what would otherwise be wasted/discarded contents out of the inside.

As can be seen in the figures, a tongue 150 can form a wall of a groove 140. Similarly, a groove 140 can be formed adjacent a tongue 150 and/or between two tongues 150. The grooves 140 and/or the tongues 150 can be formed on an interior and/or an exterior surface of the first coupling section 118 and/or the second coupling section 128. For example, in at least one embodiment, one or more groove(s) 140 are formed in an interior surface and an exterior surface of the first coupling section 118 and/or the second coupling section 128. In at least one embodiment, one or more tongue(s) 150 are formed in an interior surface and an exterior surface of the first coupling section 118 and/or the second coupling section 128. In at least one embodiment, one or more groove(s) 140 and one or more tongue(s) 150 are formed in an interior surface of the first coupling section 118 and/or the second coupling section 128. In at least one embodiment, one or more groove(s) 140 and one or more tongue(s) 150 are formed in an exterior surface of the first coupling section 118 and/or the second coupling section 128.

In at least one embodiment, a bottle, such as an at least partially plastic bottle, can include two or more at least partially separable portions for allowing a user to readily access the interior and/or contents of the bottle. For example, first and second bottle portions can be configured to be openable or optionally uncoupled from one another for facilitating removal of the remaining contents of the bottle once the primary removal means (e.g., squeezing or pumping) becomes ineffective or impractical, such as due to a relatively small amount of contents remaining in the bottle (or otherwise).

In at least one embodiment, a bottle can include an upper portion having a top end with a mouth and a longitudinally opposite bottom end, and a lower portion having a top end and a longitudinally opposite closed base, wherein the bottom end of the upper portion and the top end of the lower portion are open, and wherein the bottom end of the upper portion and the top end of the lower portion are configured to be removably and sealingly coupled with one another. The bottom end of the upper portion can include a neck, such as a recessed neck, which can have an exterior surface, such as a radially, perimetrically, perimetrally or other exterior surface. The top end of the lower portion can include an interior surface, such as a radially, perimetrically, perimetrally or other interior surface. The exterior surface of the neck and the interior surface of the lower portion can be configured to sealingly engage one another. One or more seals can be disposed on the exterior surface of the neck, interior surface of the lower portion, or otherwise disposed for supporting sealing engagement between two or more bottle portions.

In at least one embodiment, a bottle can include a plurality of male couplers coupled to one of the upper and lower portions and a plurality of female couplers coupled to the other of the upper and lower portions. The plurality of male couplers can be configured to releasably couple with the plurality of female couplers. In at least one embodiment, one or more bottle portions can have a single coupler. In at least one embodiment, one or more bottle portions can have one or more male couplers and one or more female couplers. One or more couplers can be or include any type of coupler for supporting removable coupling of two or more bottle portions according to an implementation of the disclosure. Examples of suitable couplers include flexible snap-fit or interference fit couplers as shown in the figures for illustrative purposes, among many others, such as threads, tongue and groove couplers, hook and groove couplers, and other couplers capable of being integrally formed with or otherwise coupled to one or more bottle portions. In at least one embodiment, the couplers can be absent and two or more bottle portions can be configured to couple with one another via interference fit or otherwise.

In at least one embodiment, a bottle can include one or more notches, channels, or grooves around an inner and/or outer surface of a male coupler of a top portion of the bottle that selectively interlock, or engage, one or more ridges, flanges, tongues, or protrusions around an inner and/or outer surface of a female coupler of a bottom portion of the bottle. In at least one embodiment, a bottle can include one or more notches, channels, or grooves around an inner and/or outer surface of a male coupler of a bottom portion of the bottle that selectively interlock, or engage, one or more ridges, flanges, tongues, or protrusions around an inner and/or outer surface of a female coupler of a top portion of the bottle. In at least one embodiment, a bottle can include one or more notches, channels, or grooves around an inner and/or outer surface of a female coupler of a top portion of the bottle that selectively interlock, or engage, one or more ridges, flanges, tongues, or protrusions around an outer surface of a male coupler of a bottom portion of the bottle. In at least one embodiment, a bottle can include one or more notches, channels, or grooves around an inner and/or outer surface of a female coupler of a bottom portion of the bottle that selectively interlock, or engage, one or more ridges, flanges, tongues, or protrusions around an outer surface of a male coupler of a top portion of the bottle. The surfaces of the couplers can be tapered to aid in the manufacturing, or molding, process and/or coupling and decoupling the portions of the bottle. In at least one embodiment, the couplers can include both notches, channels, or grooves and ridges, flanges, tongues, or protrusions to ensure a secure fit between the portions of the bottle.

In at least one embodiment, a bottle can include one or more seals, such as a rubber or other elastomeric seal, and one or more seals can be sized and arranged for being fluidically isolated from an interior volume of the bottle. For example, a seal can be coupled to at least one bottle portion and can be fluidically isolated from the interior of the bottle when two bottle portions are coupled together, which can be advantageous, for instance, in implementations of the disclosure wherein the seal or seal material could negatively affect the contents of the bottle or vice versa. The one or more seals can be retained within one or more of the notches, channels, or grooves, or can be outside the groves one another surface of the couplers. Any one or more of the notches, channels, or grooves, can include an elastomeric seal, such as silicone or rubber, to seal the contents within the bottle.

In at least one embodiment, each of the notches, channels, or grooves can include an elastomeric seal to sealingly engage with a corresponding one of the ridges, flanges, tongues, or protrusions. In at least one embodiment, one of the notches, channels, or grooves includes an elastomeric seal to sealingly engage with a corresponding one of the ridges, flanges, tongues, or protrusions and another one of the notches, channels, or grooves does not include an elastomeric seal but rather engages with a corresponding one of the ridges, flanges, tongues, or protrusions to ensure a secure fit between the portions of the bottle. In at least one embodiment, one of the notches, channels, or grooves includes an elastomeric seal to sealingly engage with a flat surface of the bottle.

In at least one embodiment, a bottle can include an upper portion having a primary mouth and a first coupling section, and a lower portion having a closed base, a secondary mouth and a second coupling section. In at least one embodiment, the first coupling section can be configured to be disposed at least partially through the secondary mouth and removably coupled with the second coupling section for removably coupling the upper and lower portions of the bottle with one another. In at least one embodiment, the first coupling section can include an exterior surface, a first groove that extends radially inwardly relative to the exterior surface, a first tongue that extends radially outwardly from the exterior surface, the first tongue being disposed below the first groove, a seal that extends radially outwardly relative to the exterior surface, the seal being disposed below the first tongue, and a downwardly facing rim. In at least one embodiment, the second coupling section can include an interior surface and an exterior surface, a second tongue that extends radially inwardly from the exterior surface, a second groove that extends radially outwardly from the interior surface, the second groove being disposed below the second tongue, a sealing surface disposed below the second groove, and an upwardly facing rim. In at least one embodiment, when the upper and lower portions of the bottle are coupled with one another, the first groove engages the second tongue, the first tongue engages the second groove, the seal sealingly engages the sealing surface, and the downwardly facing rim abuts the upwardly facing rim.

In at least one embodiment, the primary mouth can be smaller than the secondary mouth. In at least one embodiment, the first tongue can be or include a ramped or curved surface that increases in diameter from bottom to top. In at least one embodiment, the first tongue can intersect a wall of the first groove.

In at least one embodiment, the seal can be formed integrally with the first coupling section. In at least one embodiment, the seal can be an elastically deformable sealing element disposed in a seal groove that extends radially inwardly relative to the exterior surface of the first coupling section.

In at least one embodiment, a bottle can include an upper portion having a primary mouth and a first coupling section, and a lower portion having a closed base and a second coupling section. In at least one embodiment, the first coupling section can be configured to be removably coupled with the second coupling section for removably coupling the upper and lower portions of the bottle with one another. In at least one embodiment, the first coupling section can include an exterior surface, a first groove that extends radially inwardly relative to the exterior surface, a first sealing surface that extends around the exterior surface, the first sealing surface being disposed below the first groove, and a seal disposed adjacent the first sealing surface. In at least one embodiment, the second coupling section can include an interior surface, a tongue that extends radially inwardly from the interior surface, and a second sealing surface disposed below the tongue. In at least one embodiment, when the upper and lower portions of the bottle are coupled with one another, the first groove engages the tongue and the seal sealingly engages both sealing surfaces.

In at least one embodiment, a lower wall of the first groove can include a ramped or curved surface that increases in diameter from bottom to top. In at least one embodiment, the first sealing surface can include a second groove that extends radially inwardly relative to the exterior surface of the first coupling section. In at least one embodiment, the second sealing surface can include a third groove that extends radially outwardly relative to the interior surface of the second coupling section.

In at least one embodiment, the seal can be formed integrally with the first coupling section. In at least one embodiment, the seal can be an elastically deformable sealing element disposed in a seal groove that extends radially inwardly relative to the exterior surface of the first coupling section. In at least one embodiment, the seal is compressed longitudinally when the first groove engages the tongue. In at least one embodiment, the first sealing surface longitudinally compresses the seal against the second sealing surface when the first groove engages the tongue.

In at least one embodiment, a bottle can include an upper portion having a primary mouth and a first coupling section, and a lower portion having a closed base and a second coupling section. In at least one embodiment, the first coupling section can be configured to be removably coupled with the second coupling section for removably coupling the upper and lower portions of the bottle with one another. In at least one embodiment, the first coupling section can include an exterior surface, a tongue that extends radially outwardly relative to the exterior surface, a first sealing surface that extends around the exterior surface, the first sealing surface being disposed below the tongue, and a seal disposed adjacent the first sealing surface. In at least one embodiment, the second coupling section can include an interior surface, a first groove that extends radially outwardly from the interior surface, and a second sealing surface disposed below the first groove. In at least one embodiment, when the upper and lower portions of the bottle are coupled with one another, the first groove engages the tongue and the seal sealingly engages both sealing surfaces.

In at least one embodiment, the tongue can include a ramped or curved surface that increases in diameter from bottom to top. In at least one embodiment, the seal can be an elastically deformable sealing element disposed in a seal groove that extends radially inwardly relative to the exterior surface of the first coupling section. In at least one embodiment, the first sealing surface can include a second groove that extends radially inwardly relative to the exterior surface of the first coupling section. In at least one embodiment, the second sealing surface can include a third groove that extends radially outwardly relative to the interior surface of the second coupling section.

In at least one embodiment, the seal can be formed integrally with the first coupling section. In at least one embodiment, the seal can be compressed longitudinally when the first groove engages the tongue. In at least one embodiment, the first sealing surface longitudinally compresses the seal against the second sealing surface when the first groove engages the tongue.

In at least one embodiment, a bottle can include a hand pump coupled to the mouth and a feed tube having a first end coupled to the hand pump and a second end disposed within the bottle. The bottle can be configured so that the upper and lower portions can be uncoupled from one another, such as for gaining access to contents of the bottle that either have not been removed or cannot be removed via the hand pump and feed tube. In at least one embodiment, the mouth of the upper portion of a bottle can be or include a first mouth and the top end of the lower portion of the bottle can be or include a second mouth disposed vertically beneath the first mouth.

In at least one embodiment, a bottle can include an upper portion and a lower portion made from different materials. In at least one embodiment, one of the upper and lower portions of a bottle can be made from a more rigid material than the other of the upper and lower portions, which can facilitate coupling and/or uncoupling of the bottle portions. In at least one embodiment, one of the upper and lower portions of a bottle can be made from a thinner material than the other of the upper and lower portions, which can facilitate coupling and/or uncoupling of the bottle portions. In at least one embodiment, a bottle can include notches, channels, or grooves and/or ridges, flanges, tongues, or protrusions on other surfaces of the bottle to ensure a secure grip when coupling and/or decoupling the portions of the bottle.

In at least one embodiment, a bottle can include an upper portion hingedly secured to a lower portion. The bottle can also include the various notches, channels, grooves, ridges, flanges, tongues, protrusions, and/or seals described elsewhere. In at least one embodiment, a bottle can also include one or more finger or other recesses to assist in separating the upper portion from the lower portion. The various notches, channels, grooves, ridges, flanges, tongues, protrusions described herein can be continuous around the bottle, and/or intermittently dispersed around the bottle. The various notches, channels, grooves, ridges, flanges, tongues, protrusions described herein can be spirally disposed around the bottle, and thereby form threads to selectively couple and/or decouple the portions of the bottle.

A bottle according to the disclosure can be configured to hold any content or contents required or desired for an implementation of the disclosure, including but not limited to fluids and semi-fluids. Some of many examples of an implementation of the present disclosure include (but are by no means limited to) shampoo bottles, conditioner bottles, lotion bottles, oil bottles, soap bottles, condiment bottles, cleaning product bottles and bottles for virtually any other product or substance capable of being stored in or utilized from a bottle, specifically including, without limitation, products and substances that are susceptible to being at least partially wasted when stored in or utilized from conventional bottles. Further, a bottle according to the disclosure can be of any size or shape required or desired according to an implementation of the disclosure, including but not limited to having cross-sectional shapes that are circular, square, rectangular, triangular, oblong, irregular, polygonal or otherwise, separately or in combination, in whole or in part.

As shown in, e.g., FIGS. 30-52, for illustrative purposes, in at least one embodiment of bottle 100, upper portion 110 can be the male portion and lower portion or cup 120 can be the female portion, such that the coupling section of portion 110 can be disposed at least partially within the coupling section of portion 120. However, as will be appreciated by a person of ordinary skill in the art having the benefits of the present disclosure, this need not be the case and, in at least embodiment of bottle 100, upper portion 110 can be the female portion and lower portion or cup 120 can be the male portion, such that the coupling section of portion 120 can be disposed at least partially within the coupling section of portion 110, and the various couplers, surfaces and aspects of bottle 100 can be arranged to function as otherwise described herein.

For example, in at least one embodiment, a bottle can include an upper portion having a primary mouth and a first coupling section, a lower portion having a closed base, a secondary mouth and a second coupling section, and a seal for sealingly engaging the first and second coupling sections. The first coupling section can be configured to be disposed at least partially around or about the secondary mouth and removably coupled with the second coupling section for removably coupling the upper and lower portions of the bottle with one another. The second coupling section can include an exterior surface, a first groove that extends radially inwardly relative to the exterior surface, a first tongue that extends radially outwardly from the exterior surface, the first tongue being disposed below the first groove, and an upwardly facing rim.

The first coupling section can include an interior surface and an exterior surface, a second tongue that extends radially inwardly from the interior surface, a second groove that extends radially outwardly from the interior surface, the second groove being disposed below the second tongue, and a downwardly facing rim. When the upper and lower portions of the bottle are coupled with one another, the first groove engages the second tongue, the first tongue engages the second groove, and the seal sealingly engages the downwardly facing rim and the upwardly facing rim.

In at least one embodiment, the primary mouth can be smaller than the secondary mouth. In at least one embodiment, one or more tongues can be or include a ramped, stepped or curved surface that increases in diameter from bottom to top or top to bottom for supporting the application of sealing force(s) in one or more directions on a seal sealingly coupled with the first and second bottle portions. One or more tongues can intersect or engage a wall of one or more grooves. One or more seals can be formed integrally with one or more of the first and second coupling sections, or can be formed separately and disposed on or coupled to one or more of the first and second coupling sections. A seal can include an elastically deformable sealing element (e.g., an O-ring or gasket) disposed in a seal groove (which can include at least partially in a seal groove) that extends radially inwardly or outwardly relative to a surface of one or more of the first and second coupling sections. In at least one embodiment, a seal can be or include an adhesive, which can help support sealing engagement of the bottle portions until intentionally separate by a user for accessing contents of the bottle. Alternatively, or collectively, one or more additional seals, such as a sheet of plastic or other liquid-resistant material, can be disposed on an interior and/or exterior surface of the bottle (e.g., via adhesive, heat staking, shrink wrapping or otherwise), such as adjacent to an intersection or junction of the first and second bottle portions, for supporting sealing engagement of the bottle portions.

In at least one embodiment, a bottle can include an upper portion having a primary mouth and a first coupling section, a lower portion having a closed base and a second coupling section, and one or more seals for sealingly engaging the first and second coupling sections. The first coupling section can be configured to be removably coupled with the second coupling section for removably coupling the upper and lower portions of the bottle with one another.

One or more coupling sections can include one or more grooves and one or more sealing surfaces. One or more coupling sections can include one or more tongues and one or more sealing surfaces. One or more sealing surfaces can be disposed beneath or lower than one of more grooves and/or one or more tongues. One or more tongues and one or more grooves can be configured for coupling with one another and forcing one or more seals into sealing engagement with one or more sealing surfaces.

In at least one embodiment, one or more tongues and/or grooves can be or include a ramped, stepped or curved surface that increases in diameter from bottom to top or top to bottom for supporting the application of sealing force(s) in one or more directions on a seal sealingly coupled with the first and second bottle portions. In at least one embodiment, a seal can include an elastically deformable sealing element disposed in a seal groove. In at least one embodiment, a first sealing surface can include a groove that extends radially inwardly relative to the exterior surface of a coupling section and a second sealing surface can include a groove that extends radially outwardly relative to the interior surface of the coupling section (and/or vice versa). The sealing sections can be configured for compressing a seal longitudinally (i.e., upwardly and/or downwardly, in the direction of a longitudinal axis of the bottle) when the groove(s) and tongue(s) of the coupling sections are coupled to one another, which of course can result in lateral expansion of the seal and consequent lateral sealing forces upon contact with laterally disposed portions of the bottle (e.g., side walls or other sealing surfaces). In at least one embodiment, sealing surfaces on the coupling sections can be or include upwardly and downwardly facing rims, lips or shoulders.

In at least one embodiment, a bottle can include an upper portion having a primary mouth and a first coupling section, a lower portion having a closed base and a second coupling section, and a seal for sealingly engaging the first and second coupling sections. The first and second coupling sections can be configured to be removably coupled with one another for removably coupling the upper and lower portions of the bottle with one another.

One coupling section can include a tongue that extends radially inwardly or outwardly relative to a surface and a first sealing surface. Another coupling section can include a groove that extends radially inwardly or outwardly relative to a surface and a second sealing surface. The tongue and the groove can be configured to engage one another and to cause compression of the seal into sealing engagement with both sealing surfaces. In at least one embodiment, a tongue and/or a groove can include a ramped, stepped or curved surface that increases in diameter (or other dimension, as the case may be) in one or more directions.

A seal can be configured to sealingly engage an intersection or junction (which can include a fluid path) of the first and second coupling sections. One or more grooves and/or other sealing surfaces can be configured for supporting sealing engagement of a seal with sealing surfaces on both sides of a fluid path, such as in a T-intersection or similar configuration for helping minimize any potential for fluid to pass by the seal. In at least one embodiment, at least a portion of one or more sealing sections can be stiffer or otherwise more resistant to deformation relative to one or more other bottle portions for helping support fluid tight connection between one or more bottle portions until such portions are intentionally separated by a user. In at least one embodiment, a seal can be plastically deformable or include a plastically deformable portion and can be plastically deformed for sealing engagement between first and second bottle portions. A seal can, but need not, be disposed at least partially within one or more grooves, as required or desired according to a physical implementation of the disclosure.

In at least one embodiment, a first sealing surface can include a groove that extends radially inwardly relative to the exterior surface of a coupling section and a second sealing surface can include a groove that extends radially outwardly relative to the interior surface of a coupling section. One or more seals can be compressed longitudinally and/or laterally when first and second bottle portions are coupled to one another. One or more sealing surfaces can be configured to longitudinally compress a seal against one or more other sealing surfaces when a tongue (aka “tooth”) engages a groove for coupling first and second bottle portions to one another.

Other and further embodiments utilizing one or more aspects of the disclosure can be devised without departing from the spirit of Applicant's disclosure. For example, the devices, systems and methods can be implemented for bottles of numerous different types and sizes in numerous different industries. Further, the various methods and embodiments of the devices, systems and methods can be included in combination with each other to produce variations of the disclosed methods and embodiments. Discussion of singular elements can include plural elements and vice-versa. The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the inventions has been described. Obvious modifications and alterations to the described embodiments are available to those of ordinary skill in the art having the benefits of the present disclosure. The disclosed and undisclosed embodiments are not intended to limit or restrict the scope or applicability of the inventions conceived of by the Applicant, but rather, in conformity with the patent laws, Applicant intends to fully protect all such modifications and improvements that come within the scope or range of equivalents of the following claims.

What is claimed is:

1. A bottle, comprising:
an upper portion having a primary mouth and a first coupling section;
a lower portion having a closed base, a secondary mouth and a second coupling section; and
a seal for sealingly engaging the first and second coupling sections;
wherein the first coupling section is configured to be disposed at least partially through the secondary mouth and removably coupled with the second coupling section for removably coupling the upper and lower portions of the bottle with one another;
wherein the first coupling section comprises
an exterior surface;
a first groove that extends radially inwardly relative to the exterior surface;
a first tongue that extends radially outwardly from the exterior surface, the first tongue being disposed below the first groove; and
a downwardly facing rim;
wherein the second coupling section comprises
an interior surface and an exterior surface;
a second tongue that extends radially inwardly from the exterior surface;
a second groove that extends radially outwardly from the interior surface, the second groove being disposed below the second tongue; and
an upwardly facing rim;
wherein, when the upper and lower portions of the bottle are coupled with one another,
the first groove engages the second tongue;
the first tongue engages the second groove; and
the seal sealingly engages the downwardly facing rim and the upwardly facing rim.

2. The bottle of claim 1, wherein the primary mouth is smaller than the secondary mouth.

3. The bottle of claim 1, wherein the first tongue is or includes a ramped or curved surface that increases in diameter from bottom to top.

4. The bottle of claim 3, wherein the first tongue intersects a wall of the first groove.

5. The bottle of claim 1, wherein the seal is formed integrally with one of the first and second coupling sections.

6. The bottle of claim 1, wherein the seal comprises an elastically deformable sealing element disposed in a seal groove that extends radially inwardly relative to the exterior surface of the first coupling section and/or radially outwardly relative to the interior surface of the second coupling section.

7. A bottle, comprising:
an upper portion having a primary mouth and a first coupling section;
a lower portion having a closed base and a second coupling section; and
a seal for sealingly engaging the first and second coupling sections;
wherein the first coupling section is configured to be removably coupled with the second coupling section for removably coupling the upper and lower portions of the bottle with one another;
wherein the first coupling section comprises
an exterior surface;
a first groove that extends radially inwardly relative to the exterior surface; and
a first sealing surface that extends around the exterior surface, the first sealing surface being disposed below the first groove;
wherein the second coupling section comprises
an interior surface;
a tongue that extends radially inwardly from the interior surface; and
a second sealing surface disposed below the tongue; and
wherein, when the upper and lower portions of the bottle are coupled with one another,
the first groove engages the tongue; and
the seal sealingly engages both sealing surfaces.

8. The bottle of claim 7, wherein a lower wall of the first groove includes a ramped or curved surface that increases in diameter from bottom to top.

9. The bottle of claim 7, wherein the seal is formed integrally with one of the first and second coupling sections.

10. The bottle of claim 7, wherein the seal comprises an elastically deformable sealing element disposed in a seal groove that extends radially inwardly relative to the exterior surface of the first coupling section and/or radially outwardly relative to the interior surface of the second coupling section.

11. The bottle of claim 7, wherein the first sealing surface includes a second groove that extends radially inwardly relative to the exterior surface of the first coupling section and the second sealing surface includes a third groove that extends radially outwardly relative to the interior surface of the second coupling section.

12. The bottle of claim 7, wherein the seal is compressed longitudinally when the first groove engages the tongue.

13. The bottle of claim 7, wherein the first sealing surface longitudinally compresses the seal against the second sealing surface when the first groove engages the tongue.

14. A bottle, comprising:
an upper portion having a primary mouth and a first coupling section;
a lower portion having a closed base and a second coupling section; and
a seal for sealingly engaging the first and second coupling sections;
wherein the first and second coupling sections are configured to be removably coupled with one another for removably coupling the upper and lower portions of the bottle with one another;
wherein the first coupling section comprises
an exterior surface;
a tongue that extends radially outwardly relative to the exterior surface; and
a first sealing surface that extends around the exterior surface, the first sealing surface being disposed below the tongue;
wherein the second coupling section comprises
an interior surface;
a first groove that extends radially outwardly from the interior surface; and
a second sealing surface disposed below the first groove; and
wherein the first groove and the tongue are configured to engage one another and to cause compression of the seal into sealing engagement with both sealing surfaces.

15. The bottle of claim 14, wherein the tongue includes a ramped or curved surface that increases in diameter from bottom to top.

16. The bottle of claim 14, wherein the seal is configured to sealingly engage an intersection of the first and second coupling sections.

17. The bottle of claim 14, wherein the seal comprises an elastically deformable sealing element disposed in a seal groove that extends radially inwardly relative to the exterior surface of the first coupling section and/or radially outwardly relative to the interior surface of the second coupling section.

18. The bottle of claim 14, wherein the first sealing surface includes a second groove that extends radially inwardly relative to the exterior surface of the first coupling section and the second sealing surface includes a third groove that extends radially outwardly relative to the interior surface of the second coupling section.

19. The bottle of claim 14, wherein the seal is compressed longitudinally when the first groove engages the tongue.

20. The bottle of claim 14, wherein the first sealing surface longitudinally compresses the seal against the second sealing surface when the first groove engages the tongue.
